(19) United States
(12) Patent Application Publication
(10) Pub. No.: US 2025/0158776 A1
(43) Pub. Date: May 15, 2025

(54) METHOD AND APPARATUS FOR BEAM MEASUREMENT REPORTING

(71) Applicant: Samsung Electronics Co., Ltd., Suwon-si (KR)

(72) Inventors: Emad N. Farag, Flanders, NJ (US); Eko Onggosanusi, Coppell, TX (US); Md. Saifur Rahman, Plano, TX (US)

(21) Appl. No.: 19/026,122

(22) Filed: Jan. 16, 2025

Related U.S. Application Data
(63) Continuation of application No. 17/807,113, filed on Jun. 15, 2022, now abandoned.
(60) Provisional application No. 63/215,806, filed on Jun. 28, 2021.
(60) Provisional application No. 63/245,615, filed on Sep. 17, 2021.

(51) Int. Cl. H04L 5/00; H04W 24/10; H04W 74/00; H04W 74/0833

(52) U.S. Cl. CPC H04L 5/0051; H04W 24/10; H04W 74/006; H04W 74/0833

(57) ABSTRACT

Methods and apparatuses for beam measurement reporting in a wireless communication system. A method of operating a user equipment (UE) includes receiving, before transmission configuration indication (TCI) states are configured, first configuration information for: (i) a set of downlink (DL) reference signal resources associated with a physical downlink shared channel (PSDCH) and (ii) a set of uplink (UL) reference signal resources associated with a physical uplink shared channel (PUSCH). The method further includes measuring the set of DL reference signal resources; calculating associated metrics; transmitting a first measurement report corresponding to the set of DL reference signal resources; receiving an indication of a DL reference signal resource that indicates quasi-colocation (QCL) properties for subsequent receptions of DL channels; and receiving an indication of an UL reference signal resource that indicates a spatial domain filter for subsequent transmissions of UL channels.

### CROSS-REFERENCE TO RELATED APPLICATIONS AND CLAIM OF PRIORITY

This application is a continuation of U.S. patent application Ser. No. 17/807,113, filed on Jun. 15, 2022, which claims priority to U.S. Provisional Patent Application No. 63/215,806, filed on Jun. 28, 2021, and U.S. Provisional Patent Application No. 63/245,615, filed on Sep. 17, 2021. The contents of the above-identified patent documents are incorporated herein by reference.

### TECHNICAL FIELD

The present disclosure relates generally to wireless communication systems and, more specifically, the present disclosure relates to beam measurement reporting, for example, during initial access, in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to beam measurement reporting in a wireless communication system.

In one embodiment, a user equipment (UE) is provided. The UE includes a transceiver configured to receive, before transmission configuration indication (TCI) states are configured, first configuration information for: (i) a set of downlink (DL) reference signal resources associated with a physical downlink shared channel (PSDCH) and (ii) a set of uplink (UL) reference signal resources associated with a physical uplink shared channel (PUSCH); receive, before the TCI states are configured, the PDSCH and the set of DL reference signal resources; and transmit, before the TCI states are configured, the PUSCH and the set of UL reference signal resources. The UE further includes a processor operably coupled to the transceiver. The processor is configured to measure the set of DL reference signal resources and calculate associated metrics. The transceiver is further configured to: transmit a first measurement report corresponding to the set of DL reference signal resources; receive an indication of a DL reference signal resource that indicates quasi-colocation (QCL) properties for subsequent receptions of DL channels; and receive an indication of an UL reference signal resource that indicates a spatial domain filter for subsequent transmissions of UL channels.

In another embodiment, a BS is provided. The BS includes a transceiver configured to: transmit, before TCI states are configured, first configuration information for: (i) a set of DL reference signal resources associated with a PSDCH and (ii) a set of UL reference signal resources associated with a PUSCH; transmit, before the TCI states are configured, the PDSCH and the set of DL reference signal resources; receive, before the TCI states are configured, the PUSCH and the set of UL reference signal resources; and receive a first measurement report corresponding to the set of DL reference signal resources. The BS further includes a processor operably coupled to the transceiver. The processor is configured to determine an indicator of a DL reference signal resource from the set of DL reference signal resources to indicate QCL properties for subsequent DL channels and determine an indicator of an UL reference signal resource from the set of UL reference signal resources to indicate a spatial filter for subsequent UL channels. The transceiver is further configured to transmit information indicating the indicator of the DL reference signal resource and transmit information indicating the indicator of the UL reference signal.

In yet another embodiment, a method of operating a UE is provided. The method includes receiving, before TCI states are configured, first configuration information for: (i) a set of DL reference signal resources associated with a PSDCH and (ii) a set of UL reference signal resources associated with a PUSCH; receiving, before the TCI states are configured, the PDSCH and the set of DL reference signal resources; and transmitting, before the TCI states are configured, the PUSCH and the set of UL reference signal resources. The method further includes measuring the set of DL reference signal resources and calculate associated metrics; transmitting a first measurement report corresponding to the set of DL reference signal resources; receiving an indication of a DL reference signal resource that indicates QCL properties for subsequent receptions of DL channels; and receiving an indication of an UL reference signal resource that indicates a spatial domain filter for subsequent transmissions of UL channels.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrates an example of wireless system beam according to embodiments of the present disclosure;

FIG. 6B illustrates an example of multi-beam operation according to embodiments of the present disclosure;

FIG. 7 illustrates an example of antenna structure according to embodiments of the present disclosure;

FIG. 8 illustrates an example of direct path between the user and the base station passes through the human body according to embodiments of the present disclosure;

FIG. 9 illustrates an example of DL-TCI links target channel state information-reference signal (CSI-RS) with reference AP-CSI-RS according to embodiments of the present disclosure;

FIG. 10 illustrates an example of DL-TCI links target CSI-RS with reference AP-SRS according to embodiments of the present disclosure;

FIG. 11 illustrates an example of UL-TCI links target SRS with reference AP-CSI-RS according to embodiments of the present disclosure;

FIG. 12 illustrates an example of UL-TCI links target SRS with reference AP-SRS according to embodiments of the present disclosure;

FIG. 13 illustrates a flowchart of method for a gNB and UE processing according to embodiments of the present disclosure;

FIG. 14 illustrates an example of measurement report including maximum permissible exposure (MPE) effect according to embodiments of the present disclosure;

FIG. 15 illustrates another flowchart of method for a gNB and UE processing according to embodiments of the present disclosure;

FIG. 16 illustrates another example of measurement report including MPE effect according to embodiments of the present disclosure;

FIG. 17 illustrates an example of initial access procedures according to embodiments of the present disclosure;

FIG. 18 illustrates an example of beam transmission according to embodiments of the present disclosure;

FIG. 19 illustrates an example of RS setting according to embodiments of the present disclosure;

FIG. 20 illustrates another example of RS setting according to embodiments of the present disclosure;

FIG. 21 illustrates an example of measuring M transmission resources after the transmission of random access response (RAR) according to embodiments of the present disclosure;

FIG. 22 illustrates an example of RS resource setting according to embodiments of the present disclosure;

FIG. 23 illustrates yet another example of RS setting according to embodiments of the present disclosure;

FIG. 24 illustrates yet another example of RS setting according to embodiments of the present disclosure;

FIG. 25 illustrates another example of measuring M transmission resources after the transmission of Msg3 according to embodiments of the present disclosure;

FIG. 26 illustrates another example of RS resource setting according to embodiments of the present disclosure;

FIG. 27 illustrates an example of SSB association according to embodiments of the present disclosure; and

FIG. 28 illustrates an example of CSI-RS transmission according to embodiments of the present disclosure.

### DETAILED DESCRIPTION

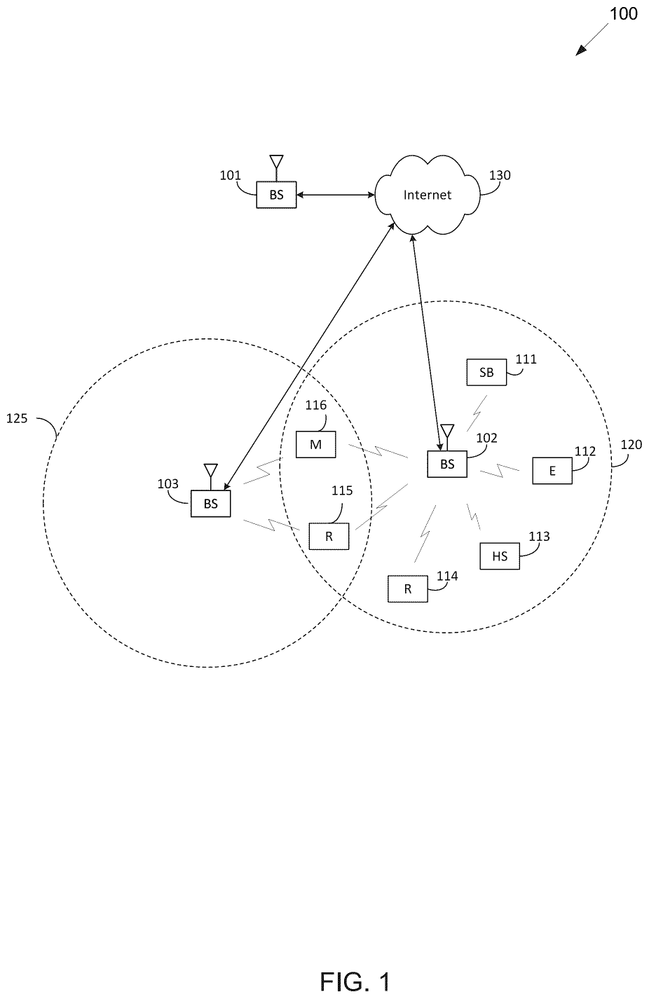

FIGS. 1 through 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.1.0, “NR; Physical channels and modulation”; 3GPP TS 38.212 v17.1.0, “NR; Multiplexing and Channel coding”; 3GPP TS 38.213 v17.1.0, “NR; Physical Layer Procedures for Control”; 3GPP TS 38.214 v17.1.0, “NR; Physical Layer Procedures for Data”; 3GPP TS 38.321 v17.0.0, “NR; Medium Access Control (MAC) protocol specification”; and 3GPP TS 38.331 v17.0.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for beam measurement reporting in a wireless communication system. In certain embodiments, and one or more of the gNBs 101-103 includes circuitry, programing, or a combination thereof, for beam measurement reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

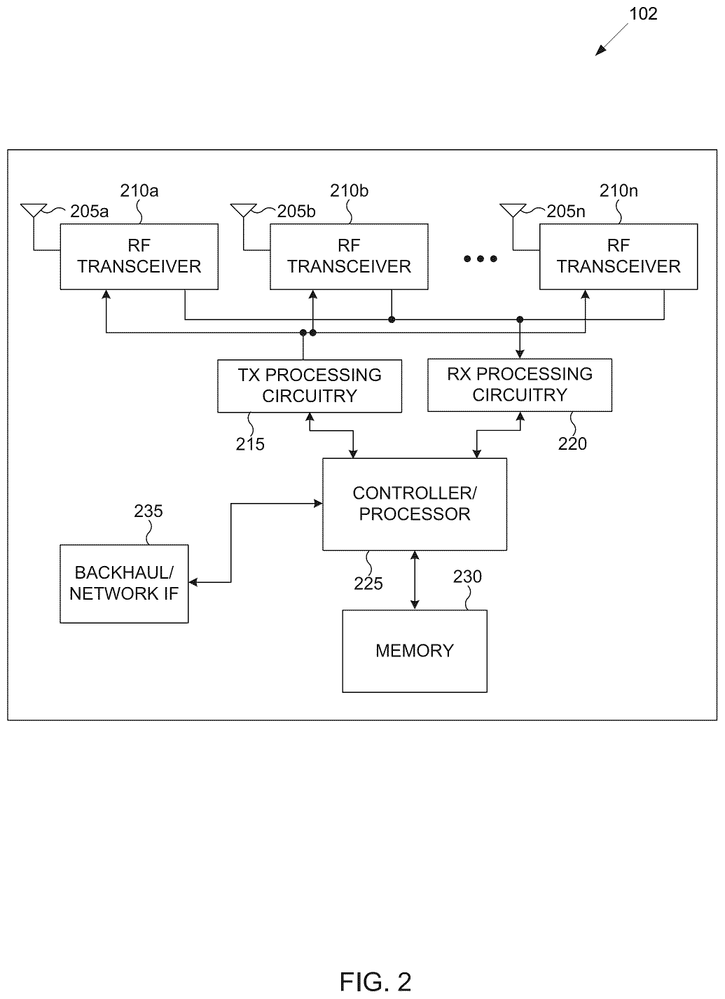

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support beam measurement reporting in a wireless communication system. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

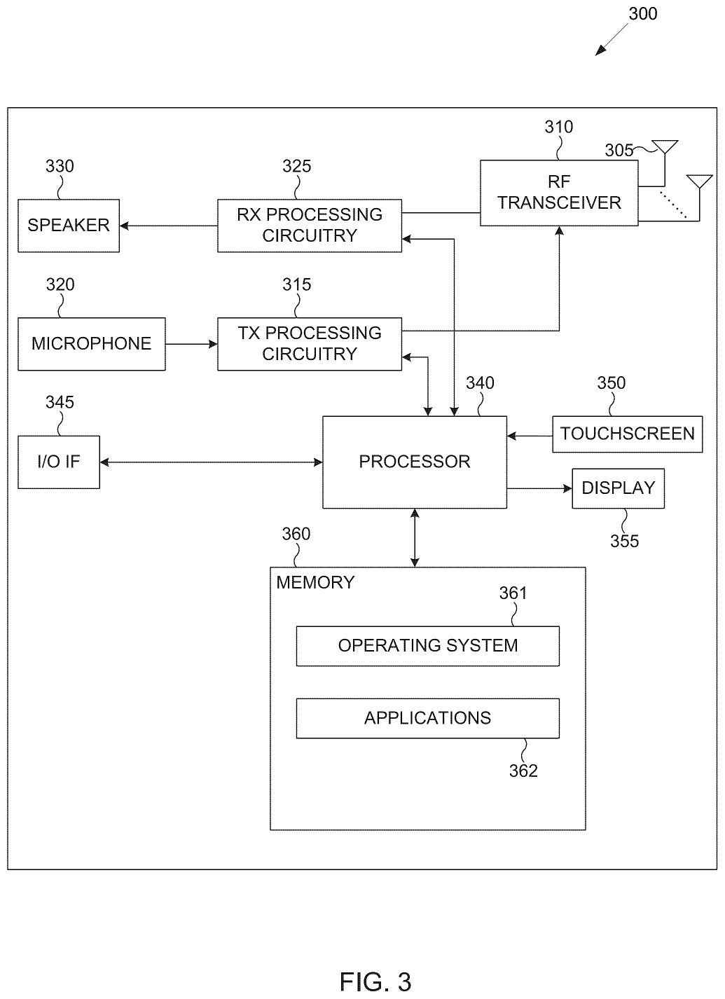

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and RX processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam measurement reporting in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

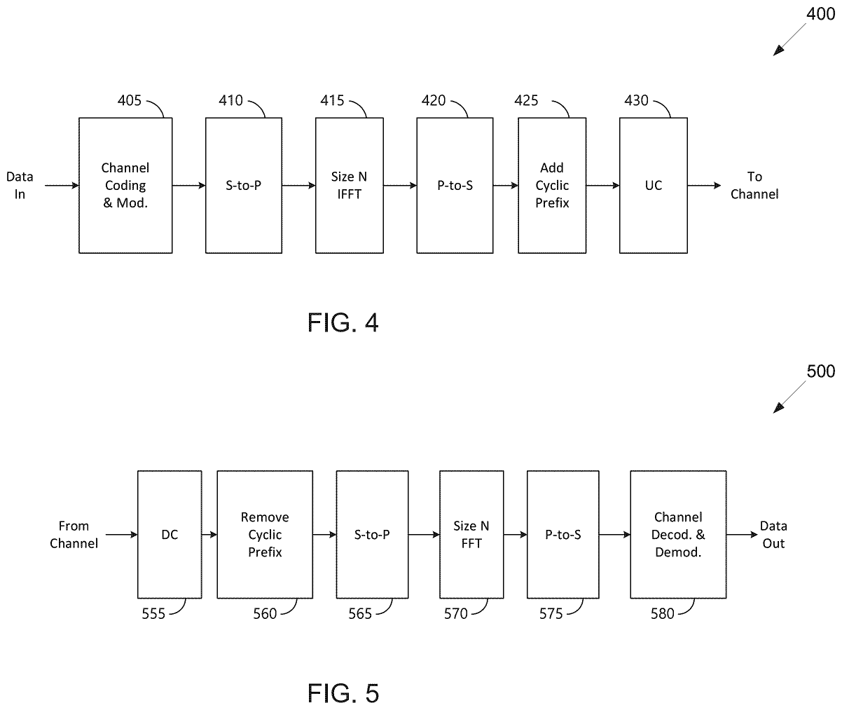

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a downconverter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. A UE can determine CSI-RS transmission parameters through DL control signaling or higher layer signaling, such as an RRC signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

3GPP Rel-17 introduced the unified TCI framework, where a unified or master or main or indicated TCI state is signaled or indicated to the UE. The unified or master or main or indicated TCI state can be one of: (1) In case of joint TCI state indication, wherein a same beam is used for DL and UL channels, a joint TCI state that can be used at least for UE-dedicated DL channels and UE-dedicated UL channels. (2) In case of separate TCI state indication, wherein different beams are used for DL and UL channels, a DL TCI state can be used at least for UE-dedicated DL channels. (3) In case of separate TCI state indication, wherein different beams are used for DL and UL channels, a UL TCI state can be used at least for UE-dedicated UL channels.

The unified (master or main or indicated) TCI state is a DL or Joint TCI state of UE-dedicated reception on PDSCH/PDCCH and the CSI-RS applying the indicated TCI state and/or an UL TCI state or a joint TCI state for dynamic-grant/configured-grant based PUSCH, PUCCH, and SRS applying the indicated TCI state.

The unified TCI framework applies to intra-cell beam management, wherein, the TCI states have a source RS that is directly or indirectly associated, through a quasi-co-location relation, e.g., spatial relation, with an SSB of a serving cell. The unified TCI state framework also applies to inter-cell beam management, wherein a TCI state can have a source RS that is directly or indirectly associated, through a quasi-co-location relation, e.g., spatial relation, with an SSB of cell that has a PCI different from the PCI of the serving cell.

A DL-related DCI Format (e.g., DCI Format 1_1 or DCI Format 1_2), with or without DL assignment, can indicate to a UE through a field “transmission configuration indication” a TCI state code point, wherein, the TCI state codepoint can be one of (1) a DL TCI state; (2) an UL TCI state; (3) a joint TCI state; or (4) a pair of DL TCI state and UL TCI state. TCI state code points are activated by MAC CE signaling.

Quasi-co-location (QCL) relation, can be quasi-location with respect to one or more of the following relations [e.g., TS 38.214-section 5.1.5]: (1) Type A, {Doppler shift, Doppler spread, average delay, delay spread} (2) Type B, {Doppler shift, Doppler spread} (3) Type C, {Doppler shift, average delay} (4) Type D, {Spatial Rx parameter}.

The unified (master or main or indicated) TCI state applies at least to UE dedicated DL and UL channels. The unified (master or main or indicated) TCI can also apply to other DL and/or UL channels and/or signals e.g., non-UE dedicated channel and sounding reference signal (SRS).

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter or quasi-co-location (QCL) properties for reception of downlink channels at the UE, or a spatial Tx filter for transmission of uplink channels from the UE.

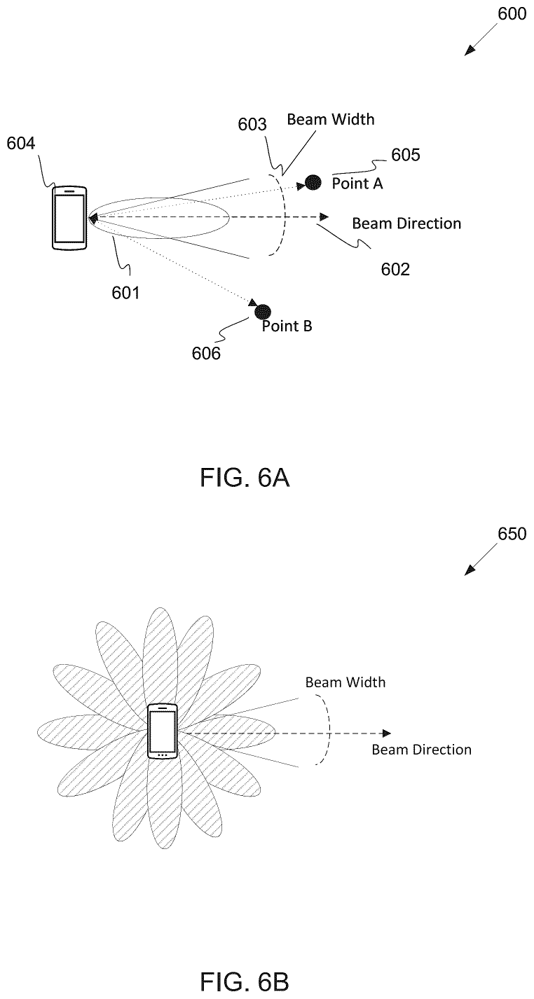

FIG. 6A illustrates an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as point A is within a beam width of a beam traveling in a beam direction and coming from the device 604.

As illustrated in FIG. 6A, a device at point B 606 cannot receive from and transmit to the device 604 as point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrates an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

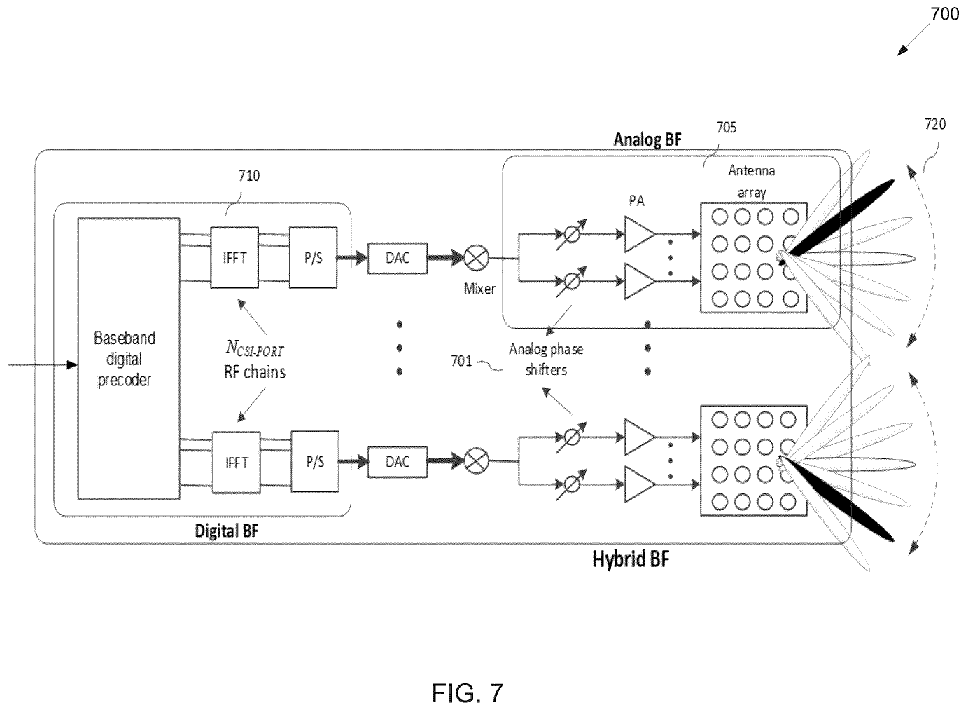

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrates an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss@100 m distance), larger number of and sharper analog beams (hence larger number of radiators in the array) may be needed to compensate for the additional path loss.

Regulatory requirements limit the UE transmit power for beams that are transmitted towards a human body to limit the maximum exposure. This is known as maximum permissible exposure (MPE). A UE experiencing MPE reduces the maximum transmission power of the UE by the power management-maximum permissible exposure (P-MPR) dB. As a result of MPE, a UE may use a different beam for UL transmission than that used for DL reception, if the UL transmission on the beam used for DL reception exceeds the maximum power due to P-MPR, a different beam can be used that does not have the P-MPR effect.

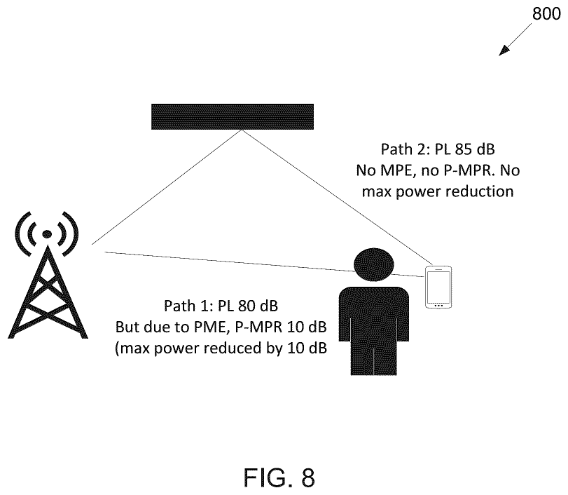

FIG. 8 illustrates an example of direct path between the user and the base station passes through the human body 800 according to embodiments of the present disclosure. An embodiment of the direct path between the user and the base station passes through the human body 800 shown in FIG. 8 is for illustration only.

In FIG. 8, the direct path (path 1) between the user and the base station passes through the human body, and so while the direct path has pathloss of 80 dB (for example), the maximum power is reduced by 10 dB (for example from 23 dBm to 13 dBm). On the other hand, a path 2 is another path between the user and the base station, the path 2 has more PL (85 dB for example) than that of path 1, yet path 2 does not pass through the human body there is no MPE effect no P-MPR and the UE is allowed to transmit with maximum power (i.e., 23 dBm) when using this path. Consider the following two examples.

In one example, uplink transmission of 10 dBm from path 1, or 15 dBm from path 2 is provided. In such example, both transmissions arrive at the gNB with the same UL-RSRP, as path 1 has an extra 5 dB PL over path 2. In this example, while both path 1 and path 2 are feasible from the UE, it is preferred to use path 1 over path 2 as path 1 has a lower transmit power.

In another example, uplink transmission of 16 dBm from path 1, or 21 dBm from path 2 is provided. In such example, UL transmission is not feasible on path 1, as the transmission power (16 dBm) exceeds the maximum allow transmission power for path 1 (13 dBm). Transmission over path 2 is feasible, as the transmission power of path 2 (21 dBm) is less than the maximum transmission power of path 2 (23 dBm). In this example transmission from path 2 is preferred.

To assist the network in deciding which path to select for uplink transmission, the measurement report including MPE effect has the measurement RS arranged in order of preference for the UE. For example, the first measurement RS (index 0) in the measurement is the most preferred RS. One example of preferred measurement RS is that with the least UL transmit power if the least UL transmit power can meet the power requirements for the UL transmission. The gNB can select a beam for uplink transmission that corresponds to the most preferred beam for the UE to use (i.e., lowest index in the beam measurement report) and that meets the power requirements of the UL transmission.

The beam measurement report including the MPE effect has the measurement RS or Joint/UL TCI state arranged in order of preference for the UE. From the beam measurement report, the gNB can select the most preferred beam that meets the power of an UL transmission from the UE.

In the present disclosure, both FDD and TDD are considered as a duplex method for DL and UL signaling. Although exemplary descriptions and embodiments to follow assume OFDM or OFDMA, the present disclosure can be extended to other OFDM-based transmission waveforms or multiple access schemes such as filtered OFDM (F-OFDM).

The present disclosure considers several components that can be used in conjunction or in combination with one another or can operate as standalone schemes.

In the present disclosure, the term “activation” describes an operation wherein a UE receives and decodes a signal from the network (or gNB) that signifies a starting point in time. The starting point can be a present or a future slot/subframe or symbol and the exact location is either implicitly or explicitly indicated or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated or is otherwise specified in the system operation or is configured by higher layers. Upon successfully decoding the signal, the UE responds according to an indication provided by the signal.

Terminology such as TCI, TCI states, SpatialRelationInfo, target RS, reference RS, and other terms is used for illustrative purposes and is therefore not normative. Other terms that refer to same functions can also be used.

A “reference RS” corresponds to a set of characteristics of a DL beam or an UL TX beam, such as a direction, a precoding/beamforming, a number of ports, and so on. For instance, for DL, as the UE receives a reference RS index/ID, for example through a field in a DCI format, which is represented by a TCI state, the UE applies the known characteristics of the reference RS to associated DL reception. The reference RS can be received and measured by the UE (for example, the reference RS is a downlink signal such as NZP CSI-RS and/or SSB) and the UE can use the result of the measurement for calculating a beam report (in Rel-15 NR, a beam report includes at least one L1-RSRP accompanied by at least one CRI). Using the received beam report, the NW/gNB can assign a particular DL TX beam to the UE.

A reference RS can also be transmitted by the UE (for example, the reference RS is an uplink signal such as SRS). As the NW/gNB receives the reference RS from the UE, the NW/gNB can measure and calculate information used to assign a particular DL TX beam to the UE. This option is applicable at least when there is DL-UL beam pair correspondence.

In another instance, for UL transmissions, a UE can receive a reference RS index/ID in a DCI format scheduling an UL transmission such as a PUSCH transmission and the UE then applies the known characteristics of the reference RS to the UL transmission. The reference RS can be received and measured by the UE (for example, the reference RS is a downlink signal such as NZP CSI-RS and/or SSB) and the UE can use the result of the measurement to calculate a beam report. The NW/gNB can use the beam report to assign a particular UL TX beam to the UE. This option is applicable at least when DL-UL beam pair correspondence holds. A reference RS can also be transmitted by the UE (for example, the reference RS is an uplink signal such as SRS or DMRS). The NW/gNB can use the received reference RS to measure and calculate information that the NW/gNB can use to assign a particular UL TX beam to the UE.

The reference RS can be triggered by the NW/gNB, for example via DCI in case of aperiodic (AP) RS or can be configured with a certain time-domain behavior, such as a periodicity and offset in case of periodic RS or can be a combination of such configuration and activation/deactivation in case of semi-persistent RS.

For mm Wave bands (or FR 2) or for higher frequency bands (such as >52.6 GHz) where multi-beam operation is especially relevant, a transmission-reception process includes a receiver selecting a receive (RX) beam for a given TX beam. For DL multi-beam operation, a UE selects a DL RX beam for every DL TX beam (that corresponds to a reference RS). Therefore, when DL RS, such as CSI-RS and/or SSB, is used as reference RS, the NW/gNB transmits the DL RS to the UE for the UE to be able to select a DL RX beam. In response, the UE measures the DL RS, and in the process selects a DL RX beam, and reports the beam metric associated with the quality of the DL RS. In this case, the UE determines the TX-RX beam pair for every configured (DL) reference RS. Therefore, although this knowledge is unavailable to the NW/gNB, the UE, upon receiving a DL RS associated with a DL TX beam indication from the NW/gNB, can select the DL RX beam from the information the UE obtains on all the TX-RX beam pairs.

Conversely, when an UL RS, such as an SRS and/or a DMRS, is used as reference RS, at least when DL-UL beam correspondence or reciprocity holds, the NW/gNB triggers or configures the UE to transmit the UL RS (for DL and by reciprocity, this corresponds to a DL RX beam). The gNB, upon receiving and measuring the UL RS, can select a DL TX beam. As a result, a TX-RX beam pair is derived. The NW/gNB can perform this operation for all the configured UL RSs, either per reference RS or by “beam sweeping,” and determine all TX-RX beam pairs associated with all the UL RSs configured to the UE to transmit.

The following two embodiments (A-1 and A-2) are examples of DL multi-beam operations that utilize DL-TCI-state based DL beam indication. In the first example embodiment (A-1), an aperiodic CSI-RS is transmitted by the NW/gNB and received/measured by the UE. This embodiment can be used regardless of whether or not there is UL-DL beam correspondence. In the second example embodiment (A-2), an aperiodic SRS is triggered by the NW and transmitted by the UE so that the NW (or a gNB) can measure the UL channel quality for the purpose of assigning a DL RX beam. This embodiment can be used at least when there is UL-DL beam correspondence. Although aperiodic RS is considered in the two examples, a periodic or a semi-persistent RS can also be used.

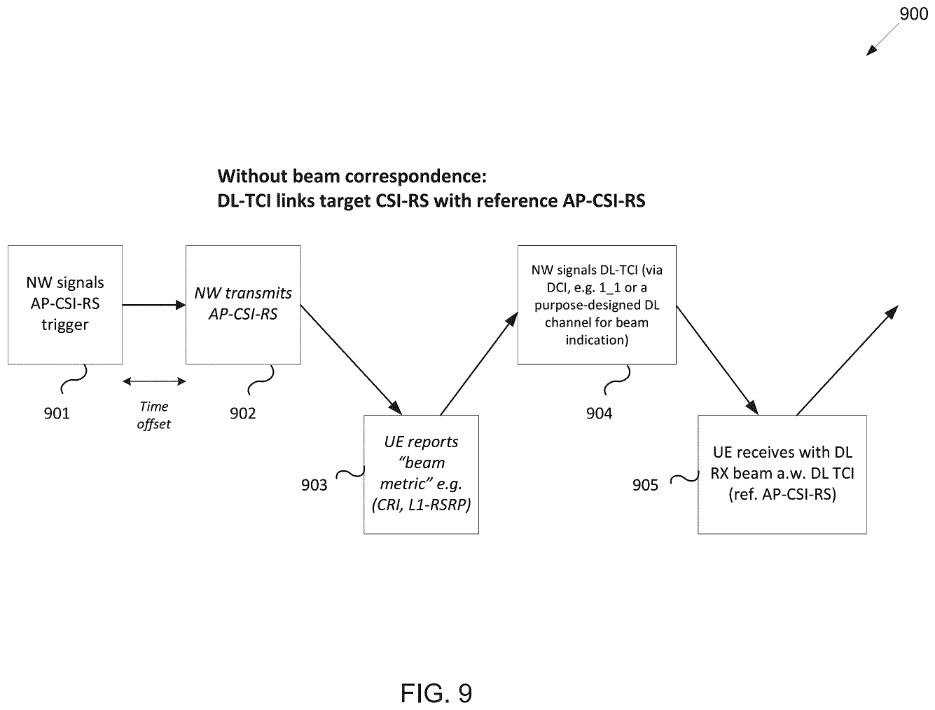

FIG. 9 illustrates an example of DL-TCI links target CSI-RS with reference AP-CSI-RS 900 according to embodiments of the present disclosure. An embodiment of the DL-TCI links target CSI-RS with reference AP-CSI-RS 900 shown in FIG. 9 is for illustration only.

In one example as illustrated in FIG. 9 (embodiment A-1), a DL multi-beam operation starts with the gNB/NW signaling to a UE an aperiodic CSI-RS (AP-CSI-RS) trigger or indication (step 901). This trigger or indication can be included in a DCI and indicate transmission of AP-CSI-RS in a same (zero-time offset) or in a later slot/sub-frame (>0 time offset). For example, the DCI can be related to scheduling of a DL reception, or an UL transmission and the CSI-RS trigger can be either jointly or separately coded with a CSI report trigger. Upon receiving the AP-CSI-RS transmitted by the gNB/NW (step 902), the UE measures the AP-CSI-RS and calculates and reports a “beam metric” that indicates a quality of a particular TX beam hypothesis (step 903). Examples of such beam reporting are a CSI-RS resource indicator (CRI), or a SSB resource indicator (SSB-RI), coupled with an associated L1-RSRP/L1-RSRQ/L1-SINR/CQI.

Upon receiving the beam report from the UE, the gNB/NW can use the beam report to select a DL RX beam for the UE and indicate the DL RX beam selection (step 904) using a TCI-state field in a DCI format such as a DCI format scheduling a PDSCH reception by the UE. In this case, a value of the TCI-state field indicates a reference RS, such as an AP-CSI-RS, representing the selected DL TX beam (by the gNB/NW). In addition, the TCI-state can also indicate a “target” RS, such as a CSI-RS, which is linked to the reference RS, such as an AP-CSI-RS. Upon successfully decoding the DCI format providing the TCI-state, the UE selects an DL RX beam and performs DL reception, such as a PDSCH reception, using the DL RX beam associated with the reference CSI-RS (step 905).

Alternatively, the gNB/NW can use the beam report to select a DL RX beam for the UE and indicate to the UE the selected DL RX beam (step 904) using a value of a TCI-state field in a purpose-designed DL channel for beam indication, or a DL related DCI Format (e.g., DCI Format 1_1 or DCI Format 1_2) for beam indication with or without a DL assignment. A purpose-designed DL channel for beam indication can be UE-specific or for a group of UEs. For example, a UE-specific DL channel can be a PDCCH that a UE receives according to a UE-specific search space (USS) while a UE-group common DL channel can be a PDCCH that a UE receives according to a common search space (CSS). In this case, the TCI-state indicates a reference RS, such as an AP-CSI-RS, representing the selected DL TX beam (by the gNB/NW). In addition, the TCI-state can also indicate a “target” RS, such as a CSI-RS, which is linked to the reference RS, such as an AP-CSI-RS. Upon successfully decoding the purpose-designed DL channel for beam indication with the TCI state, the UE selects a DL RX beam and performs DL reception, such as a PDSCH reception, using the DL RX beam associated with the reference CSI-RS (step 905).

For this embodiment (A-1), as described above, the UE selects a DL RX beam using an index of a reference RS, such as an AP-CSI-RS, which is provided via the TCI state field, for example in a DCI format. In this case, the CSI-RS resources or, in general, the DL RS resources including CSI-RS, SSB, or a combination of the two, that are configured to the UE as the reference RS resources can be linked to (associated with) a “beam metric” reporting such as CRI/L1-RSRP or L1-SINR.

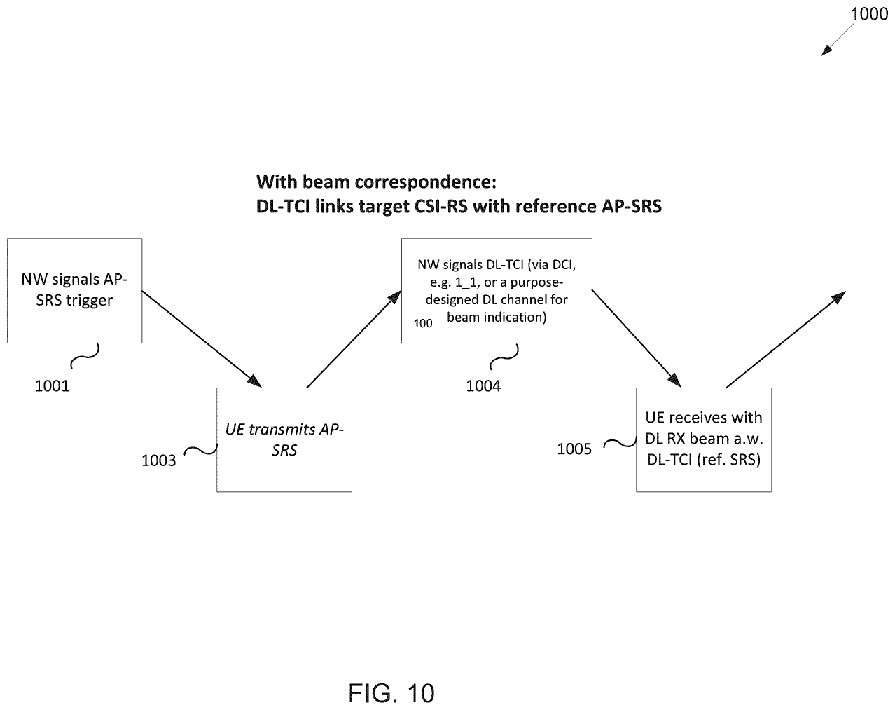

FIG. 10 illustrates an example of DL-TCI links target CSI-RS with reference AP-SRS 1000 according to embodiments of the present disclosure. An embodiment of the DL-TCI links target CSI-RS with reference AP-SRS 1000 shown in FIG. 10 is for illustration only.

In another example as illustrated in FIG. 10 (embodiment A-2), an DL multi-beam operation starts with the gNB/NW signaling to a UE an aperiodic SRS (AP-SRS) trigger or request (step 1001). This trigger can be included in a DCI format such as for example a DCI format scheduling a PDSCH reception or a PUSCH transmission. Upon receiving and decoding the DCI format with the AP-SRS trigger (step 1002), the UE transmits an SRS (AP-SRS) to the gNB/NW (step 1003) so that the NW (or gNB) can measure the UL propagation channel and select a DL RX beam for the UE for DL (at least when there is beam correspondence).

The gNB/NW can then indicate the DL RX beam selection (step 1004) through a value of a TCI-state field in a DCI format, such as a DCI format scheduling a PDSCH reception. In this case, the TCI state indicates a reference RS, such as an AP-SRS, representing the selected DL RX beam. In addition, the TCI state can also indicate a “target” RS, such as a CSI-RS, which is linked to the reference RS, such as an AP-SRS. Upon successfully decoding the DCI format providing the TCI state, the UE performs DL receptions, such as a PDSCH reception, using the DL RX beam indicated by the TCI-state (step 1005).

Alternatively, the gNB/NW can indicate the DL RX beam selection (step 1004) to the UE using a TCI-state field in a purpose-designed DL channel for beam indication, or a DL related DCI Format (e.g., DCI Format 1_1 or DCI Format 1_2) for beam indication with or without a DL assignment. A purpose-designed DL channel for beam indication can be UE-specific or for a group of UEs. For example, a UE-specific DL channel can be a PDCCH that a UE receives according to a USS while a UE-group common DL channel can be a PDCCH that a UE receives according to a CSS. In this case, the TCI-state indicates a reference RS, such as an AP-SRS, representing the selected DL RX beam. In addition, the TCI-state can also indicate a “target” RS, such as a CSI-RS, which is linked to the reference RS, such as an AP-SRS. Upon successfully decoding a purpose-designed DL channel for beam indication with the TCI-state, the UE performs DL reception, such as a PDSCH reception, with the DL RX beam indicated by the TCI-state (step 1005).

For this embodiment (A-2), as described above, the UE selects the DL RX beam based on the UL TX beam associated with the reference RS (AP-SRS) index signaled via the TCI-state field.

Similar, for UL multi-beam operation, the gNB selects an UL RX beam for every UL TX beam that corresponds to a reference RS. Therefore, when an UL RS, such as an SRS and/or a DMRS, is used as a reference RS, the NW/gNB triggers or configures the UE to transmit the UL RS that is associated with a selection of an UL TX beam. The gNB, upon receiving and measuring the UL RS, selects an UL RX beam. As a result, a TX-RX beam pair is derived. The NW/gNB can perform this operation for all the configured reference RSs, either per reference RS or by “beam sweeping,” and determine all the TX-RX beam pairs associated with all the reference RSs configured to the UE. Conversely, when a DL RS, such as a CSI-RS and/or an SSB, is used as reference RS (at least when there is DL-UL beam correspondence or reciprocity), the NW/gNB transmits the RS to the UE (for UL and by reciprocity, this RS also corresponds to an UL RX beam).

In response, the UE measures the reference RS (and in the process selects an UL TX beam) and reports the beam metric associated with the quality of the reference RS. In this case, the UE determines the TX-RX beam pair for every configured (DL) reference RS. Therefore, although this information is unavailable to the NW/gNB, upon receiving a reference RS (hence an UL RX beam) indication from the NW/gNB, the UE can select the UL TX beam from the information on all the TX-RX beam pairs.

The following two embodiments (B-1 and B-2) are examples of UL multi-beam operations that utilize TCI-based UL beam indication after the network (NW) receives a transmission from the UE. In the first example embodiment (B-1), a NW transmits an aperiodic CSI-RS, and a UE receives and measures the CSI-RS. This embodiment can be used, for instance, at least when there is reciprocity between the UL and DL beam-pair-link (BPL). This condition is termed “UL-DL beam correspondence.” In the second example embodiment (B-2), the NW triggers an aperiodic SRS transmission from a UE and the UE transmits the SRS so that the NW (or a gNB) can measure the UL channel quality for the purpose of assigning an UL TX beam. This embodiment can be used regardless of whether or not there is UL-DL beam correspondence. Although aperiodic RS is considered in these two examples, periodic or semi-persistent RS can also be used.

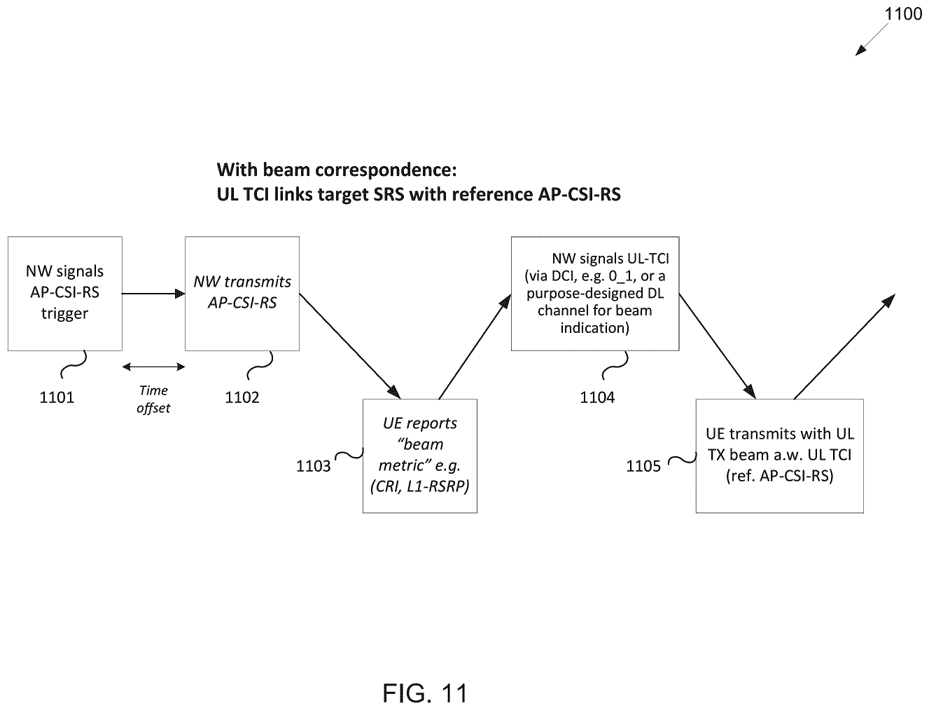

FIG. 11 illustrates an example of UL-TCI links target SRS with reference AP-CSI-RS 1100 according to embodiments of the present disclosure. An embodiment of the UL-TCI links target SRS with reference AP-CSI-RS 1100 shown in FIG. 11 is for illustration only.

In one example as illustrated in FIG. 11 (embodiment B-1), an UL multi-beam operation starts with the gNB/NW signaling to a UE an aperiodic CSI-RS (AP-CSI-RS) trigger or indication (step 1101). This trigger or indication can be included in a DCI format, such as a DCI format scheduling a PDSCH reception to the UE or a PUSCH transmission from the UE and can be either separately or jointly signaled with an aperiodic CSI request/trigger, and indicate transmission of AP-CSI-RS in a same slot (zero time offset) or in a later slot/sub-frame (>0 time offset). Upon receiving the AP-CSI-RS transmitted by the gNB/NW (step 1102), the UE measures the AP-CSI-RS and, in turn, calculates and reports a “beam metric” (indicating quality of a particular TX beam hypothesis) (step 1103). Examples of such beam reporting are CSI-RS resource indicator (CRI) or SSB resource indicator (SSB-RI) together with an associated L1-RSRP/L1-RSRQ/L1-SINR/CQI.

Upon receiving the beam report from the UE, the gNB/NW can use the beam report to select an UL TX beam for the UE and indicate the UL TX beam selection (step 1104) using a TCI-state field in a DCI format, such as a DCI format scheduling a PUSCH transmission from the UE. The TCI-state indicates a reference RS, such as an AP-CSI-RS, representing the selected UL RX beam (by the gNB/NW). In addition, the TCI-state can also indicate a “target” RS, such as an SRS, which is linked to the reference RS, such as an AP-CSI-RS. Upon successfully decoding the DCI format indicating the TCI-state, the UE selects an UL TX beam and performs UL transmission, such as a PUSCH transmission, using the UL TX beam associated with the reference CSI-RS (step 1105).

Alternatively, the gNB/NW can use the beam report to select an UL TX beam for the UE and indicate the UL TX beam selection (step 1104) to the UE using a value of a TCI-state field in a purpose-designed DL channel for beam indication or a DL related DCI Format (e.g., DCI Format 1_1 or DCI Format 1_2) for beam indication with or without a DL assignment. A purpose-designed DL channel for beam indication can be UE-specific or for a group of UEs. For example, a UE-specific DL channel can be a PDCCH that a UE receives according to a USS while a UE-group common DL channel can be a PDCCH that a UE receives according to a CSS. In this case, the TCI-state indicates a reference RS, such as an AP-CSI-RS, representing the selected UL RX beam (by the gNB/NW). In addition, the TCI-state can also indicate a “target” RS, such as an SRS, which is linked to the reference RS, such as an AP-CSI-RS. Upon successfully decoding a purpose-designed DL channel providing a beam indication by the TCI-state, the UE selects an UL TX beam and performs UL transmission, such as a PUSCH transmission, using the UL TX beam associated with the reference CSI-RS (step 1105).

For this embodiment (B-1), as described above, the UE selects the UL TX beam based on the derived DL RX beam associated with the reference RS index signaled via the value of the TCI-state field. In this case, the CSI-RS resources or, in general, the DL RS resources including CSI-RS, SSB, or a combination of the two, that are configured for the UE as the reference RS resources can be linked to (associated with) “beam metric” reporting such as CRI/L1-RSRP or L1-SINR.

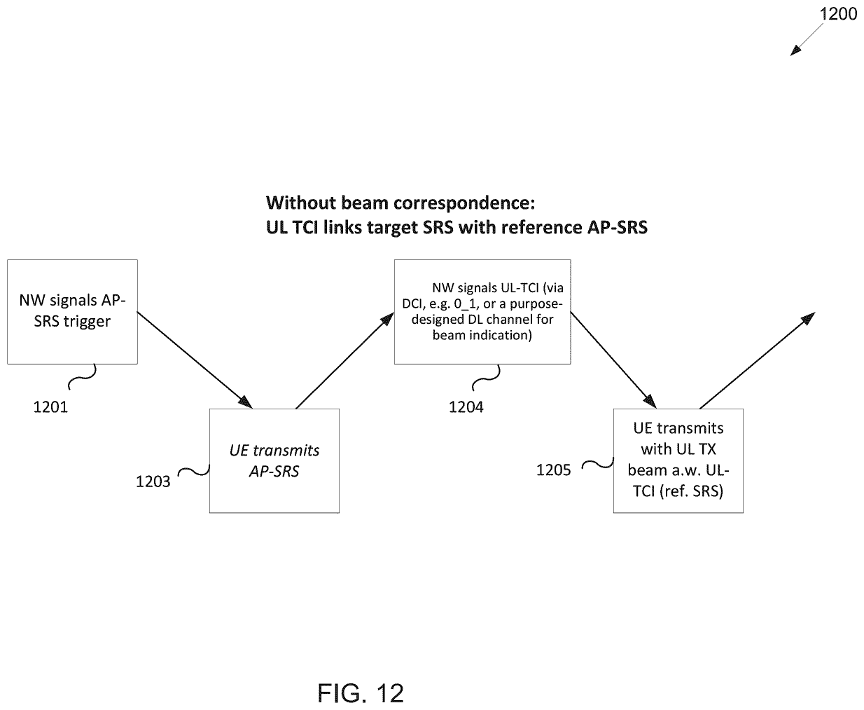

FIG. 12 illustrates an example of UL-TCI links target SRS with reference AP-SRS 1200 according to embodiments of the present disclosure. An embodiment of the UL-TCI links target SRS with reference AP-SRS 1200 shown in FIG. 12 is for illustration only.

In another example as illustrated in FIG. 12 (embodiment B-2), an UL multi-beam operation starts with the gNB/NW signaling to a UE an aperiodic SRS (AP-SRS) trigger or request (step 1201). This trigger can be included in a DCI format, such as a DCI format scheduling a PDSCH reception or a PUSCH transmission. Upon receiving and decoding the DCI format with the AP-SRS trigger (step 1202), the UE transmits AP-SRS to the gNB/NW (step 1203) so that the NW (or gNB) can measure the UL propagation channel and select an UL TX beam for the UE.

The gNB/NW can then indicate the UL TX beam selection (step 1204) using a value of the TCI-state field in the DCI format. In this case, the UL-TCI indicates a reference RS, such as an AP-SRS, representing the selected UL TX beam. In addition, the TCI-state can also indicate a “target” RS, such as an SRS, which is linked to the reference RS, such as an AP-SRS. Upon successfully decoding the DCI format providing a value for the TCI-state, the UE transmits, for example a PUSCH or a PUCCH, using the UL TX beam indicated by the TCI-state (step 1205).

Alternatively, a gNB/NW can indicate the UL TX beam selection (step 1204) to the UE using a value of a TCI-state field in a purpose-designed DL channel for beam indication, or a DL related DCI Format (e.g., DCI Format 1_1 or DCI Format 1_2) for beam indication with or without a DL assignment. A purpose-designed DL channel for beam indication can be UE-specific or for a group of UEs. For example, a UE-specific DL channel can be a PDCCH that a UE receives according to a USS while a UE-group common DL channel can be a PDCCH that a UE receives according to a CSS. In this case, the UL-TCI indicates a reference RS, such as an AP-SRS, representing the selected UL TX beam. In addition, the TCI-state can also indicate a “target” RS, such as an SRS, which is linked to the reference RS, such as an AP-SRS. Upon successfully decoding a purpose-designed DL channel for beam indication through a value of the TCI-state field, the UE transmits, such as a PUSCH or a PUCCH, using the UL TX beam indicated by the value of the TCI-state (step 1205).

For this embodiment (B-2), as described above, the UE selects the UL TX beam from the reference RS (in this case SRS) index signaled via the value of the TCI-state field.

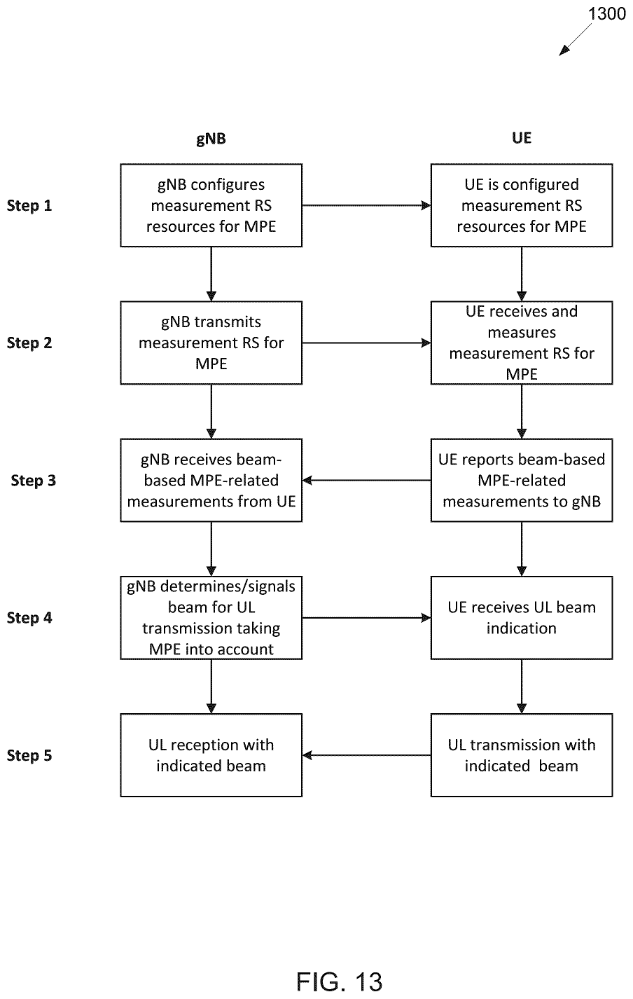

FIG. 13 illustrates a flowchart of method 1300 for a gNB and UE processing according to embodiments of the present disclosure. The method 1300 as may be performed by a UE (e.g., 111-116 as illustrated in FIG. 1) and a BS (e.g., 101-103 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, in step 1, the UE is configured with measurement RS for MPE, wherein the measurement RS can be one or more of: (1) SSB, wherein the SSBRI identifies the measurement RS for MPE; (2) CSI-RS, wherein the CRI identifies the measurement RS for MPE; (3) DMRS of PDCCH; or (4) DMRS of PDSCH.

In step 2, the gNB transmits a measurement RS. The UE measures the measurement RS. The measurement can be one or more of: (1) DL RSRP of measurement RS, e.g., L1 RSRP; (2) DL SINR of measurement RS; or (3) Pathloss (PL) of measurement RS or of a pathloss RS associated with the measurement RS, wherein: PL_{b,f,c}(q_{d})=referenceSignalPower−higher layer filtered RSRP, where, b is the UL BWP, f is the carrier, c is the serving cell, and q_{d} is the RS used for pathloss measurement.

In one example, q_{d} is the measurement RS. In another example, q_{d} is a pathloss RS associated with the measurement. referenceSignalPower is transmit power of the reference signal provided by higher layers: (1) if the UE is not configured periodic CSI-RS reception, referenceSignalPower is provided by ss-PBCH-BlockPower; (2) if the UE is configured periodic CSI-RS reception, referenceSignalPower is provided either by ss-PBCH-BlockPower or by powerControlOffsetSS providing an offset of the CSI-RS transmission power relative to the SS/PBCH block transmission power. If powerControlOffsetSS is not provided to the UE, the UE assumes an offset of 0 dB; (3) if UE is configured with measurement RS of PDSCH DMRS or PDCCH DMRS, referenceSignalPower is the power of the corresponding reference signal.

In a variant, L1 RSRP is used instead of higher layer filtered RSRP for determining the PL, i.e.: PL_{b,f,c}(q_{d})=referenceSignalPower−L1 RSRP.

A UE further determines at least one of: (1) power management-maximum power reduction (P-MPR) associated with each measurement RS, wherein the P_MPR_{f,c}(q_{q}) is the reduction in maximum power due to the maximum permissible exposure for carrier f, cell c and measurement RS q_{d}: (2) the UE reduces the maximum transmit power by P_MPR_{b,f,c}(q_{d}) to account for P_MPR reduction resulting in a maximum power of P_{CMAX,f,c}(i, q_{d}) for carrier f, cell c and measurement RS q_{d} in transmission instance i; or (3) virtual power head room (vPHR) associated with each measurement RS, wherein the vPHR is defined as: vPHR_{b,f,c}(i, j, q_{d}, l)=P_{CMAX,f,c}(i, q_{d})−{P_{O}_{_{PUSCH,}}_{b,f,c}(i)+10 log₁₀(2^{μ}^{_{ref}}M_{R,B,b,f,c}^{ref,PUSCH}(i))+α_{b,f,c}(j)PL_{b,f,c}(q_{d})+Δ_{TF,ref,b,f,c}+f_{b,f,c}(i, l)} [dB]. Wherein: (1) μ_{ref} is the sub-carrier spacing of a reference UL transmission; (2) M_{R,B,b,f,c}^{ref,PUSCH} is the number of PRBs of a reference UL transmission; (3) Δ_{TF,ref,b,f,c} is an adjustment based on the transport format of the references UL transmission; and (4) the rest of the parameters are as described in 3GPP standard specification (TS 38.213).

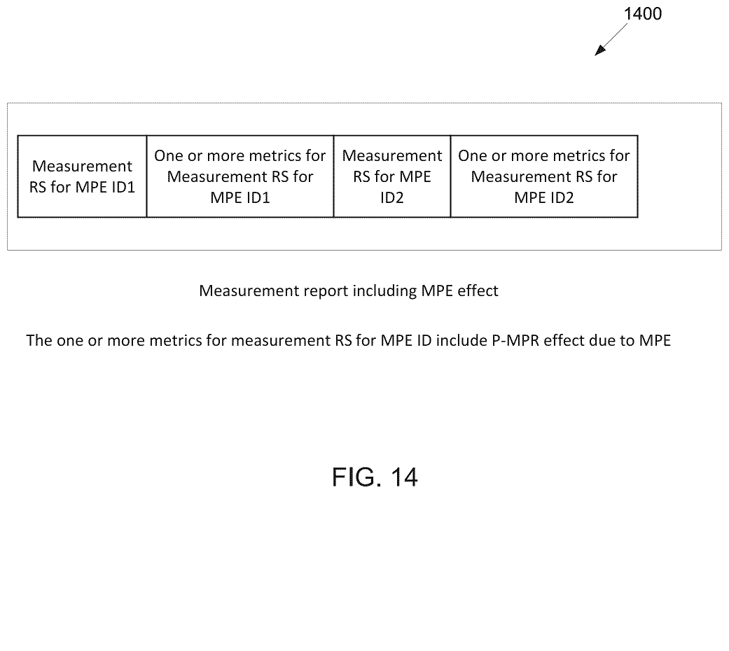

In step 3, the UE reports MPE-related measurements to the gNB taking into account the P-MPR. Included in the measurement report is one or more measurement RS IDs and associated metrics, as shown in FIG. 14.

FIG. 14 illustrates an example of measurement report including MPE effect 1400 according to embodiments of the present disclosure. An embodiment of the measurement report including MPE effect 1400 shown in FIG. 14 is for illustration only.

The MPE-related metrics for the measurement RS can be one or more of: (1) virtual power headroom—vPHR_{b,f,c}(i, j, q_{d}, l)—following the above equation; (2) P-MPR−P_MPR_{f,c}(q_{d}); (3) maximum transmit power after reducing by P-MPR−P_{CMAX,f,c}(i, q_{d}); (4) maximum UL RSRP at the gNB: P_{CMAX,f,c}(i, q_{d})−PL_{b,f,c}(q_{d}); (5) maximum UL RSRP at the gNB adjusted by the partial pathloss factor alpha: P_{CMAX,f,c}(i, q_{d})−α_{b,f,c}(j)PL_{b,f,c}(q_{d}); (6) DL RSRP of measurement RS at the UE; (7) DL SINR of measurement RS at the UE; (8) PL of measurement RS or PL-RS associated with the measurement RS at the UE; and/or (8) PL of measurement RS or PL-RS associated with the measurement RS at the UE adjusted (increased) by P-MPR, i.e., P_{CMAX,f,c}(i, q_{d}).

When reporting measurement RS to the network, the UE orders the measurement RS in order of preference: (1) the first measurement RS (e.g., with index 0) is the most preferred if the first measurement RS has enough powerhead room for a transmission; and (2) the second measurement RS (if any) (e.g., with index 1) is the second preferred if the second measurement RS has enough powerhead.

The ordering of the preferred beams can be based on: (1) in one example, the preferred beam is based on the DL RSRP of the measurement RS. A measurement RS with a higher DL RSRP can be preferred over a measurement RS with a lower DL RSRP; (2) in another example, the UE determines the preferred beam based on the DL SINR of the measurement RS. A measurement RS with a higher DL SINR can be preferred over a measurement RS with a lower DL SINR; (3) in another example, the UE determines the preferred beam based on the DL PL of the measurement RS. A measurement RS with a lower DL PL can be preferred over a measurement RS with a higher DL PL; (4) in another example, the UE determines the preferred beam based on the estimated UL transmit power. A beam corresponding to a measurement RS with a lower UL transmit power can be preferred over that with a higher UL transmission power.

The measurement report including the MPE effect can be included in LI beam measurement report. In this example, the beam measurement can be transmitted on PUCCH. If the PUCCH transmission that includes the beam measurement report overlaps a PUSCH transmission, the UCI with the beam measurement report is multiplexed in the PUSCH. In this example, the beam measurement report can be included in Uplink control information transmitted on PUSCH. Wherein, the PUSCH transmission can be one of: (1) a PUSCH transmissions scheduled by an UL grant; (2) a configured grant PUSCH transmission of Type 1 or of Type 2; (3) a Msg3 PUSCH transmission for random access procedure Type 1; and (4) a MsgA PUSCH transmission for random access procedure Type 2.

In this example, the metric(s) for MPE effect (e.g., virtual power headroom) is included in the L1 beam measurement report with L1 RSRP measurements and/or L1 SINR measurements.

In this example, the L1 beam measurement report includes two parts: (1) a first part consisting of one or more (SSBRI/CRI+L1 RSRP and/or L1 SINR); and (2) a second part consisting of one or more (measurement RS ID (e.g., SSBRI/CRI)+MPE effect metric (e.g., virtual power headroom)).

The measurement report including the MPE effect can be included in MAC CE report. In this example, the Rel-16 single-entry PHR MAC CE. The MAC CE is augmented to include PHR per measurement RS and possibly other metrics for MPE reporting. In this example, the Rel-16 multiple-entry PHR MAC CE. The MAC CE is modified to included PHR per measurement RS instead of or in addition to the serving cell PHR. In this example, a new MAC for reporting MPE related metrics per measurement RS for MPE. In this example, the MAC CE is included in a PUSCH transmission, wherein: (1) the PUSCH transmissions scheduled by an UL grant; (2) the PUSCH transmission is a configured grant PUSCH transmission of Type 1 or of Type 2; (3) the PUSCH transmission is a Msg3 PUSCH transmission for random access procedure Type 1; and (4) the PUSCH transmission is a MsgA PUSCH transmission for random access procedure Type 2.

In step 4, the gNB determines the estimated transmit power of an UL transmission to be scheduled from the UE. The gNB finds a beam that can satisfy the UL transmission power requirement of the uplink transmission. For example, when the UE reports the virtual power headroom, this may be a beam that have enough power headroom for the UE to transmit without reaching the maximum power (after P-MPR reduction).

In one example, a gNB can start with a beam corresponding to measurement RS with the lowest index (e.g., index 0), the gNB finds the beam corresponding to the first measurement RS in the report (i.e., measurement RS with lowest index in the measurement report) and that satisfies the UL transmission power requirements.

For example, when the UE orders the measurement RS for MPE in the measurement report including the MPE effect in order of DL RSRP and included in the measurement report is the virtual power headroom. The first measurement RS (index 0) is the measurement RS with the highest DL RSRP. If all measurement RS, or pathloss RS associated with the measurement RS, are transmitted with the same transmit power, the higher the DL RSRP, the lower the PL.

Alternatively, the ordering of the measurement RS in the measurement report including the MPE effect can be based on the PL, i.e., the first measurement RS (index 0) is the measurement RS (or associated PL-RS) with the lowest PL. At the gNB, the gNB determines the estimated transmit power of UL transmission to be scheduled from UE. The gNB determines how much more (or less) power is required over the reference power used in the calculation of the virtual power headroom. If there is enough virtual power headroom in a beam corresponding to a measurement RS, the gNB can schedule the UL transmission on that beam.

In one example, the gNB can chose the beam with the lowest index (position) in the beam measurement report and with enough power headroom for the UL transmission. This may correspond to the most preferred beam from the UE with enough power headroom for the UL transmission.

In another example, the gNB can chose any beam with enough power headroom for the UL transmission. This, in general, does not correspond to the most preferred beam from the UE with enough power headroom for the UL transmission.

In another example, there is no beam with enough power headroom for the UL transmission. The gNB can chose the beam with the largest power headroom in the measurement report.

In step 3, when the UE is reporting measurements to the gNB, the UE can order beams in order of preference. The following procedure (procedure A) can be used by the UE reported beams to network.

In one example, let N be the total number of measurement RS for MPE.

In another example, the measurement RS are ordered in order of preference starting with the most preferred measurement RS (index 0). The second most preferred measurement RS (if any) has index 1, etc.

In yet another example, report the most preferred measurement (report includes measurement RS ID and corresponding metric). This is measurement RS with index 0 in the measurement report. For index j=1 to N−1: (1) if metric (or metrics) of measurement RS corresponding to index j is better than metric (or metrics) corresponding to all measurement RS with a lower with index lower than j, measurement RS ID corresponding to index j and its corresponding metric (or metrics) are reported in the measurement report including the MPE effect. An example of a metric is the power headroom; a measurement RS m is said to have a better power headroom metric than measurement RS n, if the power headroom of measurement RS m is larger than power headroom of measurement RS n. Another example of a metric is the maximum UL-RSRP; a measurement RS m is said to have a better maximum UL RSRP metric than measurement RS n, if the maximum UL RSRP of measurement RS m is larger than the maximum UL RSRP of measurement RS n, the UL RSRP is the estimated UL RSRP at the gNB for a transmission from the UE with a reference power (e.g., maximum transmission taking into account the MPE effect); estimated UL RSRP=reference transmission power from UE−Pathloss between UE and gNB on corresponding beam; and (2) else, the measurement RS is not included in the measurement report including the MPE effect.

In another example, the UE can report measurement metrics for all measurement RS for MPE.

In another example, it can be up to UE implementation which measurement RS for MPE the UE reports metrics for.

In another example, it can be up to UE implementation to determine the order of measurement RS for MPE in a measurement report.

In another example, the behavior described by procedure A can be configured on or off, by RRC signaling and/or by MAC CE signaling. When configured off, the UE can either report metrics for all measurement RS for MPE, or it can be up to UE implementation to determine which measurement RS for MPE the UE reports metrics for.

In step 5, the UE transmits the UL transmission based on the indicated beam. The gNB receives the UL transmission based on the beam indicated to UE.

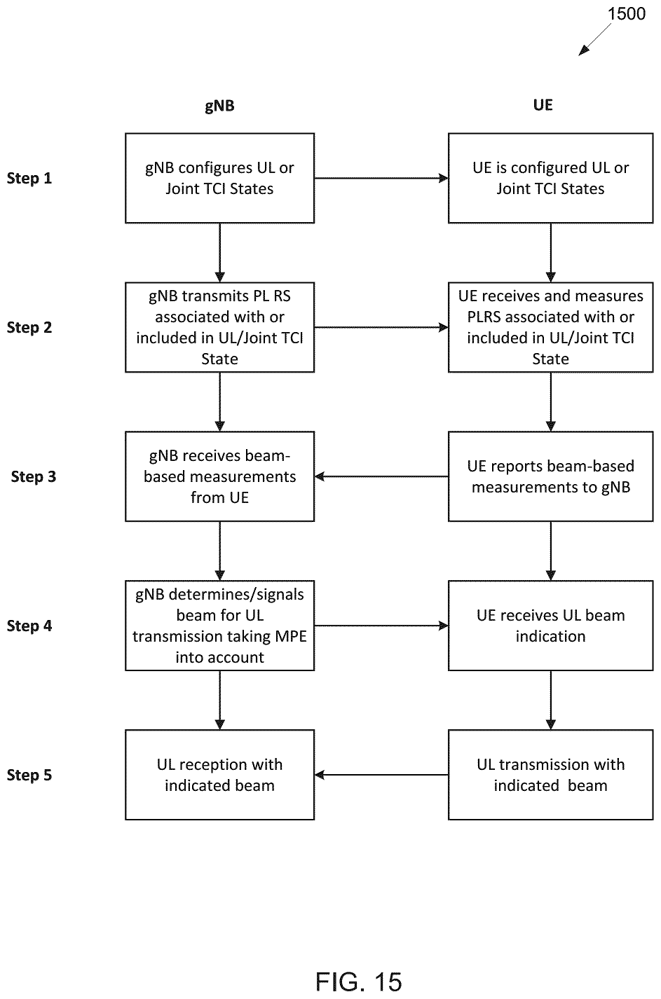

FIG. 15 illustrates another flowchart of method 1500 for a gNB and UE processing according to embodiments of the present disclosure. The method 1500 as may be performed by a UE (e.g., 111-116 as illustrated in FIG. 1) and a BS (e.g., 101-103 as illustrated in FIG. 1). An embodiment of the method 1300 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

In step 1 of FIG. 15, the UE is configured with joint TCI states or UL TCI states. A PL-RS is associated with or included in a joint TCI state or an UL TCI state.

In step 2 of FIG. 15, the gNB transmits a PL-RS, associated with a joint TCI state or an UL TCI state. The UE measures the measurement RS. The measurement RS for MPE can be the PL-RS associated with the Joint TCI state or the UL TCI state or the source RS of the Joint TCI state or UL TCI state. The measurement can be one or more of: (1) DL RSRP of PL-RS, e.g., L1 RSRP; (2) DL SINR of PL-RS; and/or (3) Pathloss (PL) of measurement RS or of a pathloss RS associated with the measurement RS, wherein: PL_{b,f,c}(q_{d})=referenceSignalPower−higher layer filtered RSRP, where, b is the UL BWP, f is the carrier, c is the serving cell, and q_{d} is the RS used for pathloss measurement.

referenceSignalPower is transmit power of the reference signal provided by higher layers: (1) if the UE is not configured periodic CSI-RS reception, referenceSignalPower is provided by ss-PBCH-BlockPower and/or (2) if the UE is configured periodic CSI-RS reception, referenceSignalPower is provided either by ss-PBCH-BlockPower or by powerControlOffsetSS providing an offset of the CSI-RS transmission power relative to the SS/PBCH block transmission power. If powerControlOffsetSS is not provided to the UE, the UE assumes an offset of 0 dB. In a variant, L1 RSRP is used instead of higher layer filtered RSRP for determining the PL, i.e., PL_{b,f,c}(q_{d})=referenceSignalPower−L1 RSRP.

A UE further determines at least one of: (1) power management-maximum power reduction (P-MPR) associated with each PL-RS associated with or included in a joint TCI state or an UL TCI state, wherein the P_MPR_{f,c}(q_{q}) is the reduction in maximum power due to the maximum permissible exposure for carrier f, cell c and PL-RS q_{d}; (2) the UE reduces the maximum transmit power by P_MPR_{b,f,c}(q_{d}) to account for P_MPR reduction resulting in a maximum power of P_{CMAX,f,c}(i, q_{d}) for carrier f, cell c and PL-RS q_{d} in transmission instance i. The PL-RS is associated with or included in a joint TCI state or an UL TCI state; and (3) virtual power head room (vPHR) associated with each PL-RS associated with or included in a joint TCI state or an UL TCI state, wherein the vPHR is defined as: vPHR_{b,f,c}(i, j, q_{d}, l)=P_{CMAX,f,c}(i, q_{d})−{P_{O}_{_{PUSCH,}}_{b,f,c}(i)+10 log₁₀(2^{μ}^{_{ref}}M_{R,B,b,f,c,}^{ref,PUSCH}(i))+α_{b,f,c}(j)PL_{b,f,c}(q_{d})+Δ_{TF,ref,b,f,c}+f_{b,f,c}(i, l)} [dB]. Wherein: (1) μ_{ref} is the sub-carrier spacing of a reference UL transmission; (2) M_{R,B,b,f,c}^{ref,PUSCH} is the number of PRBs of a reference UL transmission; (3) Δ_{TF,ref,b,f,c} is an adjustment based on the transport format of the references UL transmission; and (4) the rest of the parameters are as described in 3GPP standard specification (TS 38.213).

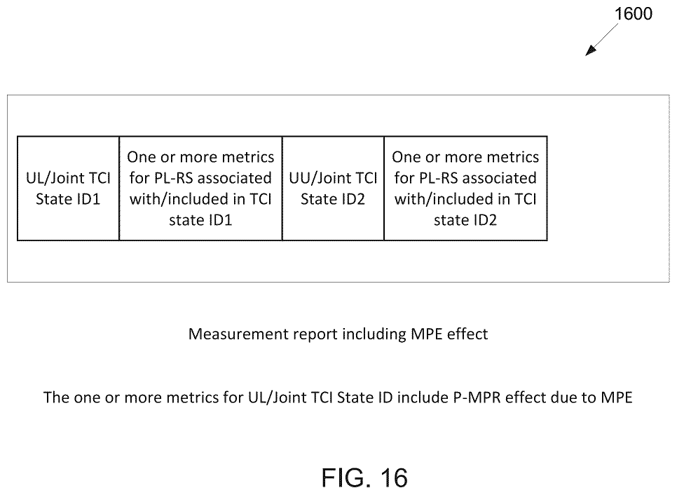

In step 3 of FIG. 15, the UE reports MPE-related measurements to the gNB taking into account the P-MPR. Included in the measurement report is one or more measurement RS IDs and associated metrics, as shown in FIG. 16.

FIG. 16 illustrates another example of measurement report including MPE effect 1600 according to embodiments of the present disclosure. An embodiment of the measurement report including MPE effect 1600 shown in FIG. 16 is for illustration only.

The metrics for the PL-RS associated with or included in the Joint TCI state or the UL TCI state can be one or more of: (1) virtual power headroom—vPHR_{b,f,c}(i, j, q_{d}, l)—following the above equation; (2) P-MPR−P_MPR_{f,c}(q_{d}); (3) maximum transmit power after reducing by P-MPR−P_{CMAX,f,c}(i, q_{d}); (4) maximum UL RSRP at the gNB: P_{CMAX,f,c}(i, q_{d})−PL_{b,f,c}(q_{d}); (5) maximum UL RSRP at the gNB adjusted by the partial pathloss factor alpha: P_{CMAX,f,c}(i, q_{d})−α_{b,f,c}(j)PL_{b,f,c}(q_{d}); (6) DL RSRP of measurement RS at the UE; (7) DL SINR of measurement RS at the UE; (8) PL of PL-RS associated with or included in the Joint TCI state or the UL TCI state at the UE; and (9) PL of PL-RS associated with or included in the Joint TCI state or the UL TCI state adjusted (increased) by P-MPR, i.e., P_{CMAX,f,c}(i, q_{d}).

When reporting Joint TCI state or UL TCI state with MPE beam measurements to the network, the UE orders the Joint TCI state or UL TCI state in order of preference.

In one example, the first Joint TCI state or UL TCI state (e.g., with index 0) is the most preferred if the first Joint TCI state or UL TCI state has enough powerhead room for a transmission.

In another example, the second Joint TCI state or UL TCI state (if any) (e.g., with index 1) is the second preferred if the second Joint TCI state or UL TCI state has enough powerhead.

The ordering of the preferred beams can be based on: (1) in one example, the preferred beam is based on the DL RSRP of the PL-RS associated with or included in the Joint TCI state or the UL TCI state. A PL-RS with a higher DL RSRP can be preferred over a PL-RS with a lower DL RSRP; (2) in another example, the UE determines the preferred beam based on the DL SINR of the PL-RS associated with or included in the Joint TCI state or the UL TCI state. A PL-RS with a higher DL SINR can be preferred over a PL-RS with a lower DL SINR; (3) in another example, the UE determines the preferred beam based on the DL PL of the PL-RS associated with or included in the Joint TCI state or the UL TCI state. A PL-RS with a lower DL PL can be preferred over a PL-RS with a higher DL PL; and (4) in another example, the UE determines the preferred beam based on the estimated UL transmit power. A beam corresponding to a Joint TCI state or an UL TCI state with a lower UL transmit power can be preferred over that with a higher UL transmission power.

In one example, the measurement report including the MPE effect can be included in an L1 beam measurement report.

In such example, the beam measurement can be transmitted on PUCCH. If the PUCCH transmission that includes the beam measurement report overlaps a PUSCH transmission, the Uplink control information (UCI) with the beam measurement report is multiplexed in the PUSCH.

In such example, the beam measurement report can be included in Uplink control information transmitted on PUSCH. Wherein, the PUSCH transmission can be one of: (1) a PUSCH transmissions scheduled by an UL grant; (2) a configured grant PUSCH transmission of Type 1 or of Type 2; (3) a Msg3 PUSCH transmission for random access procedure Type 1; and/or (4) a MsgA PUSCH transmission for random access procedure Type 2.

In such example, the metric(s) for MPE effect (e.g., virtual power headroom) is included in the L1 beam measurement report with L1 RSRP measurements and/or L1 SINR measurements.

In such example, the L1 beam measurement report includes two parts: (1) a first part consisting of one or more (SSBRI/CRI+L1 RSRP and/or L1 SINR); and/or (2) a second part comprising one or more (UL TCI state or Joint TCI state+MPE effect metric (e.g., virtual power headroom)).

In one example, the measurement report including the MPE effect can be included in MAC CE report.

In such example regarding the Rel-16 single-entry PHR MAC CE, the MAC CE is augmented to include PHR per Joint TCI state or UL TCI state and possibly other metrics for MPE reporting.

In such example regarding the Rel-16 multiple-entry PHR MAC CE, the MAC CE is modified to included PHR per Joint TCI state or UL TCI state instead of or in addition to the serving cell PHR.

In such example, a new MAC for reporting MPE related metrics per Joint TCI state or UL TCI state is provided.

In such example, the MAC CE is included in a PUSCH transmission, wherein: (1) the PUSCH transmissions scheduled by an UL grant; (2) the PUSCH transmission is a configured grant PUSCH transmission of Type 1 or of Type 2; (3) the PUSCH transmission is a Msg3 PUSCH transmission for random access procedure Type 1; and (4) the PUSCH transmission is a MsgA PUSCH transmission for random access procedure Type 2.

In step 4 of FIG. 15, the gNB determines the estimated transmit power of an UL transmission to be scheduled from the UE. The gNB finds a beam that can satisfy the UL transmission power requirement of the uplink transmission. For example, when the UE reports the virtual power headroom, this may be a beam that have enough power headroom for the UE to transmit without reaching the maximum power (after P-MPR reduction).

In one example, a gNB can start with a beam corresponding to Joint TCI state or UL TCI state with the lowest index (e.g., index 0), the gNB finds the beam corresponding to the first Joint TCI state or UL TCI state in the report (i.e., Joint TCI state or UL TCI state with lowest index in the measurement report) and that satisfies the UL transmission power requirements.

For example, when the UE orders the Joint TCI state or UL TCI state in the measurement report including the MPE effect in order of DL RSRP and included in the measurement report is the virtual power headroom. The first Joint TCI state or UL TCI state (index 0) is the measurement RS with the highest DL RSRP. If all pathloss RS associated with or included in the Joint TCI state or the UL TCI state, are transmitted with the same transmit power, the higher the DL RSRP, the lower the PL. Alternatively, the ordering of the Joint TCI state or the UL TCI state in the measurement report including the MPE effect can be based on the PL, i.e., the first Joint TCI state or UL TCI state (index 0) is the Joint TCI state or UL TCI state with the lowest PL.

At the gNB, the gNB determines the estimated transmit power of UL transmission to be scheduled from UE. The gNB determines how much more (or less) power is required over the reference power used in the calculation of the virtual power headroom. If there is enough virtual power headroom in a beam corresponding to a Joint TCI state or UL TCI state, the gNB can schedule the UL transmission on that beam.

In one example, the gNB can chose the beam with the lowest index (position) in the beam measurement report and with enough power headroom for the UL transmission. This may correspond to the most preferred beam from the UE with enough power headroom for the UL transmission.

In another example, the gNB can chose any beam with enough power headroom for the UL transmission. This, in general, does not correspond to the most preferred beam from the UE with enough power headroom for the UL transmission.

In another example, there is no beam with enough power headroom for the UL transmission. The gNB can chose the beam with the largest power headroom in the measurement report.

In step 3 of FIG. 15, when the UE is reporting measurements to the gNB, the UE can order beams in order of preference. The following procedure (procedure A) can be used by the UE reported beams to network.

In one example, let N be the total number of Joint TCI states or UL TCI states.

In another example, the Joint TCI states or UL TCI states are ordered in order of preference starting with the most preferred Joint TCI state or UL TCI state (index 0). The second most preferred Joint TCI state or UL TCI state (if any) has index 1, etc.

In yet another example, report the most preferred measurement (report includes Joint TCI state ID or UL TCI state ID and corresponding metric). This is Joint TCI state or UL TCI state with index 0 in the measurement report, for index j=1 to N−1: (1) if metric (or metrics) of Joint TCI state or UL TCI state corresponding to index j is better than metric (or metrics) corresponding to all Joint TCI state or UL TCI state with index lower than j, Joint TCI state or UL TCI state ID corresponding to index j and its corresponding metric (or metrics) are reported in the measurement report including the MPE effect. An example of a metric is the power headroom; a Joint TCI state or UL TCI state m is said to have a better power headroom metric than Joint TCI state or UL TCI state n, if the power headroom of Joint TCI state or UL TCI state m is larger than power headroom of Joint TCI state or UL TCI state n. Another example of a metric is the maximum UL-RSRP; a Joint TCI state or UL TCI state m is said to have a better maximum UL RSRP metric than Joint TCI state or UL TCI state n, if the maximum UL RSRP of Joint TCI state or UL TCI state m is larger than the maximum UL RSRP of Joint TCI state or UL TCI state n; and (2) else, the Joint TCI state or UL TCI state is not included in the measurement report including the MPE effect.

In another example, the UE can report measurement metrics for all Joint TCI states or UL TCI states.

In another example, it can be up to UE implementation which Joint TCI state or UL TCI state the UE reports metrics for.

In another example, it can be up to UE implementation to determine the order of Joint TCI state or UL TCI state in a MPE-related measurement report.

In another example, the behavior described by procedure A can be configured on or off, by RRC signaling and/or by MAC CE signaling. When configured off, the UE can either report metrics for all Joint TCI states or UL TCI states, or it can be up to UE implementation to determine which Joint TCI state or UL TCI state the UE reports metrics for.

In step 5 of FIG. 15, the UE transmits the UL transmission based on the indicated beam. The gNB receives the UL transmission based on the beam indicated to UE.

In one example, steps 1, 2 and 3 are performed according to the embodiments of FIG. 13, e.g., the network (gNB) configures and transmits reference signals for MPE measurement, the UE performs MPE related measurements on the reference signals for MPE measurements and transmits an MPE related report. Steps 4 and 5 are performed according to the embodiments of FIG. 15, e.g., there is an association between measurement RS for MPE and the source RS of UL or Joint TCI states, and the gNB determines the TCI state for UL transmission taking into account the MPE report to avoid exceeding the maximum permissible exposure.

In the present disclosure, the beam measurement report including the MPE effect has the measurement RS for MPE or UL/Joint TCI State arranged in order of preference for the UE. From the beam measurement report, the gNB can select the most preferred beam that meets the power requirement of an UL transmission from the UE.

The present disclosure presents a method for UL and DL beam refinement during initial access procedure. Based on CSI-RS associated with random access reference (RAR), SRS associated with Msg3, and preamble triggered CSI-RS.

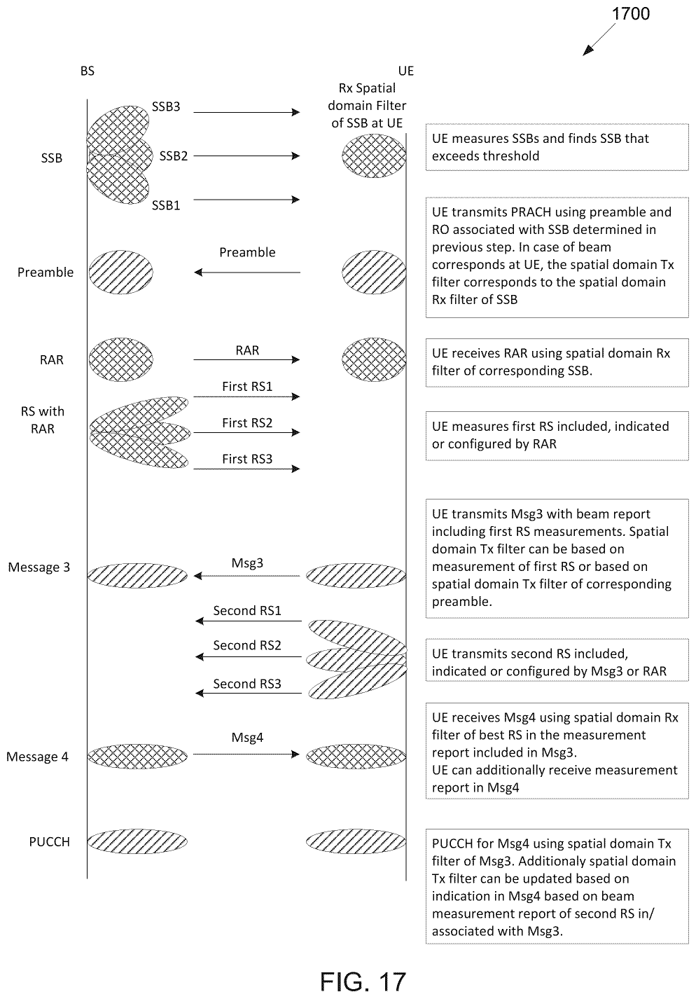

FIG. 17 illustrates an example of initial access procedures 1700 according to embodiments of the present disclosure. An embodiment of the initial access procedures 1700 shown in FIG. 17 is for illustration only.

As illustrated in FIG. 17, in step 1, a UE is provided information about SSBs and association between: (1) SSBs and random access channel (RACH) Occasions (ROs), and/or (2) SSBs and preambles.

In step 2, the UE determines an SSB and selects an RO and a preamble within that RO associated with the SSB. UE transmits PRACH on selected RO and preamble. In case of beam correspondence at the UE without beam sweeping, the UE can determine the spatial domain transmission filter for the PRACH transmission based on the spatial domain receive filter of the corresponding SSB. In case of no beam correspondence at the UE, the UE tries different hypothesis of the spatial domain transmission filter for the preamble until the UE gets a RAR response (as described in a later step in this procedure) from the gNB.

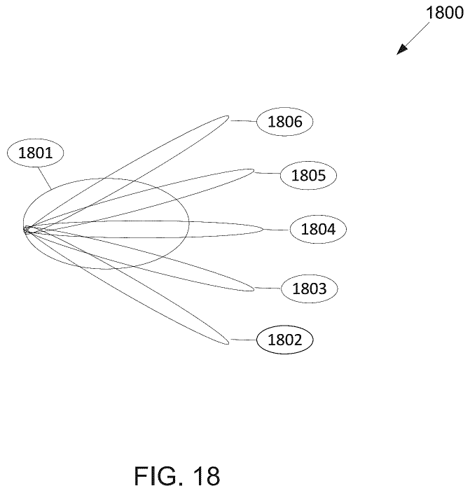

In step 3, the gNB detects preamble and determines spatial domain transmission filter or quasi-co-location (QCL) properties of DL transmissions and spatial domain reception filter of UL receptions at the gNB: (1) the spatial domain reception filter used to receive the preamble is determined based on the spatial domain transmission filter used to transmit the corresponding SSB. This can apply in case of “beam correspondence without beam sweeping” at the gNB. In this case, the spatial domain transmission filter (or QCL properties) for RAR is that used for the corresponding SSB; (2) the spatial domain reception filter is determined based on beam sweeping at the gNB. This can apply in case of “no beam correspondence without beam sweeping” at the gNB. In this case, the spatial domain transmission filter for RAR is that used for the corresponding SSB; and (3) the spatial domain reception filter is determine based on beam refinement at the gNB. For example, the gNB determines a narrow spatial domain reception filter for the preamble narrower than the spatial domain transmission filter for the SSB transmission. FIG. 18 illustrates an example for illustration purposes, wherein the wide beam 1801 correspond to wide spatial domain transmission filter for the SSB, and the narrow beams 1802 to 1806 correspond to narrow spatial domain reception (or transmission) filters, the gNB determines which beam is the best beam to receive the preamble on. The gNB further determines a narrow spatial domain transmission filter based on the narrow spatial domain reception filter to use for the transmission of the RAR. This can apply in case of “beam correspondence without beam sweeping” at the gNB.

FIG. 18 illustrates an example of beam transmission 1800 according to embodiments of the present disclosure. An embodiment of the beam transmission 1800 shown in FIG. 18 is for illustration only.

In step 4, in response to the detected preamble, the gNB transmits an RAR. The RAR includes an UL grant that schedules a Msg3 transmission from the UE. The RAR can additionally include, indicate or configure first RS resource setting for further beam measurement and beam refinement. The spatial domain transmission filter for the RAR is as determined in step 3. In one example, the resources for the first RS resource setting can be configured by RRC signaling.

In step 5, the UE receives the RAR. The UE can use the spatial domain reception filter (or QCL properties) of the corresponding SSB to receive the RAR. The UE can additionally receive and measure the first RSs included, indicated or configured in the RAR and calculate associated metrics.

In step 6, the UE transmits Msg3 in response to the RAR: (1) Msg3 can be transmitted on a UE-selected beam with a spatial domain transmission filter determined based on the measurement of the first RSs included, indicated or configured by the RAR; (2) Msg3 can be transmitted on a UE-selected beam with a spatial transmission filter determined based on the measurement of the first RSs included, indicated or configured by the RAR. Msg3 further includes a selected beam indicator, or a measurement report based on the measurement of the first RSs included, indicated or configured in the RAR; or (3) Msg3 can be transmitted on the same beam (i.e., same spatial domain transmission filter) as used for the corresponding preamble transmission. Msg3 further includes a selected beam indicator, or a measurement report based on the measurement of the first RSs included, indicated or configured in the RAR.

In step 7, Msg3 can additionally, include, indicate or configure second RS resource settings. Alternatively, the second the second RS resource setting can be indicated or configured in the RAR (e.g., in the UL grant included in the RAR). In one example, the resources for the second RS resource setting can be configured by RRC signaling.

In step 8, the gNB receives Msg3 based on the on the UL grant of the RAR: (1) the gNB can use the same spatial domain reception filter as that used for the preamble in step 3; or (2) the gNB can use a spatial domain reception filter corresponding to the one of the spatial domain transmission filters of the first RS included or indicated or configured in the RAR. Multiple receive hypothesis may be needed to successfully receive Msg3.

In step 9, the gNB further receives the selected beam indicator or the measurement report included in Msg3. The gNB updates the spatial domain transmission filter (or DL QCL properties), and, in case of beam correspondence, the spatial domain reception filter accordingly.

In step 10, the gNB receives and measures the second RSs included, indicated or configured in Msg3, or indicated or configured in the RAR (e.g., in the UL grant included in the RAR).

In step 11, the gNB transmits Msg4 in response to Msg3: (1) Msg4 can be transmitted based on the selected beam indicator in Msg3 or the best beam indicated in the measurement report included in Msg3 or based on the selected beam included in Msg3. Msg4 further includes a selected beam indicator, or a measurement report based on the measurement of the second RSs included, indicated or configured in Msg3 or indicated or configured in the RAR (e.g., in the UL grant included in the RAR); (2) Msg4 can be transmitted based on the beam used to receive Msg3, e.g., in case of beam correspondence without beam sweeping at the gNB. Msg4 further includes a selected beam indicator, or a measurement report based on the measurement of the second RSs included, indicated or configured in Msg3 or indicated or configured in the RAR (e.g., in the UL grant included in the RAR); or (3) Msg4 can be transmitted on a gNB selected beam with a spatial domain transmission filter determined based on the measurement of the second RSs included, indicated or configured by Msg3, or indicated or configured in the RAR (e.g., in the UL grant included in the RAR). Msg4 further includes a measurement report based on the measurement of the second RSs included, indicated or configured in Msg3.

In step 12, the UE receives Msg4 based using a spatial domain reception filter (or QCL properties): (1) the spatial domain reception filter is determined based on the beam measurement report included in Msg3 (e.g., the spatial domain reception filter of a RS associated with the best beam in beam report included in Msg3) or based on the selected beam included in Msg3; and (2) the UE can use a spatial domain reception filter corresponding to the one of the spatial domain transmission filters of the second RS included, indicated or configured in Msg3, or indicated or configured in the RAR (e.g., in the UL grant included in the RAR). Multiple receive hypothesis may be needed to successfully receives Msg4.

In step 13, based on the decoding status of Msg4, the UE can transmit a PUCCH: (1) PUCCH can be transmitted based on the selected beam indicator or the best beam indicated in the measurement report included in Msg4 (e.g., the spatial domain reception filter of a RS associated with the best beam in beam report included in Msg4); or (2) PUCCH can be transmitted based on the same beam (i.e., same spatial domain transmission filter) as used for the Msg3 corresponding to the associated Msg4.

In step 14, for subsequent UL/DL transmissions and receptions until TCI states are configured: (1) DL transmissions from the gNB to the UE can additionally include, indicate or configure first RS resource setting for further beam measurement and beam refinement; (2) UL transmissions from the UE to the gNB can additionally include, indicate or configure second RS resource setting for further beam measurement and beam refinement; (3) the gNB can determine when to transmit the first RS resource setting and inform the UE of the transmission; (4) the UE can send a request to the gNB to transmit first RS resource setting; (5) the UE can determine when to transmit the second RS resource setting and inform the gNB of the transmission; (6) the UE can send a request to the gNB to configure the UE to transmit the second RS resource setting; or (7) the gNB can configure (send a request to) the UE to transmit the second RS resource setting.

In step 15, for subsequent DL receptions at the UE, until TCI states are configured, the spatial domain reception filter (or QCL properties) is determined based on: (1) the beam measurement report included in Msg3 (e.g., the spatial domain reception filter (or QCL properties) of a RS associated with the best beam in beam report included in Msg3) or based on the selected beam included in Msg3; (2) a new selected beam or new measurement report included in UL transmission (e.g., the spatial domain reception filter (or QCL properties) of a RS associated with the best beam in beam report included in UL transmission) in response to a first RS included or indicated or configured by a DL transmission; (3) a DL transmission includes a DL-related DCI with a DL assignment for a DL transmission, the DL-related DCI includes a TCI state field (or similar field for beam indication), that indicates one of a first RS to use for determining the DL spatial domain reception filter (or QCL properties); (4) a DL-related DCI without a DL assignment that includes a TCI state field (or similar field for beam indication), that indicates one of a first RS to use for determining the DL spatial domain reception filter (or QCL properties); (5) a DL transmission includes a DL-related DCI with a DL assignment for a DL transmission, the DL-related DCI includes a TCI state field (or similar field for beam indication), that indicates one of a second RS to use for determining the DL spatial domain reception filter (or QCL properties); (6) a DL-related DCI without a DL assignment that includes a TCI state field (or similar field for beam indication), that indicates one of a second RS to use for determining the DL spatial domain reception filter (or QCL properties); (7) the latest UL-related DCI with or without UL grant that includes a TCI state field (or similar field for beam indication), that indicates one of a first RS to use for determining the DL spatial domain reception filter (or QCL properties); (8) the latest UL-related DCI with or without UL grant that includes a TCI state field (or similar field for beam indication), that indicates one of a second RS to use for determining the DL spatial domain reception filter (or QCL properties); and/or (9) a purpose-designed DL channel for beam indication that includes a TCI state field (or similar field for beam indication), that indicates one of a first RS to use for determining the DL spatial domain transmission filter (or QCL properties); and/or (10) a purpose-designed DL channel for beam indication that includes a TCI state field (or similar field for beam indication), that indicates one of a second RS to use for determining the DL spatial domain transmission filter (or QCL properties).

In step 16, for subsequent UL transmissions from the UE, until TCI states are configured, the spatial domain transmission filter is based one of the following: (1) the beam measurement report included in Msg4 (e.g., RS associated with the best beam in beam report included in Msg4) or based on the selected beam included in Msg4; (2) the beam measurement report included in Msg3 (e.g., RS associated with the best beam in beam report included in Msg3) or based on the selected beam included in Msg3; (3) a new selected beam or new measurement report included in UL transmission (e.g., RS associated with the best beam in beam report included in UL transmission) in response to a first RS included or indicated or configured by a DL transmission; (4) a new selected beam or new measurement report included in DL transmission (e.g., RS associated with the best beam in beam report included in DL transmission) in response to a second RS included or indicated or configured by a UL transmission; (5) an UL transmission is scheduled by an UL-related DCI with an UL grant for an UL transmission, the UL-related DCI includes a TCI state field (or similar field for beam indication), that indicates one of a first RS to use for determining the UL spatial domain transmission filter; (6) a UL-related DCI without an UL grant that includes a TCI state field (or similar field for beam indication), that indicates one of a first RS to use for determining the UL spatial domain transmission filter; (7) an UL transmission is scheduled by an UL-related DCI with an UL grant for an DL transmission, the UL-related DCI includes a TCI state field (or similar field for beam indication), that indicates one of a second RS to use for determining the UL spatial domain transmission filter; (8) an UL-related DCI without an UL grant that includes a TCI state field (or similar field for beam indication), that indicates one of a second RS to use for determining the UL spatial domain transmission filter; (9) the latest DL-related DCI with or without DL assignment that includes a TCI state field (or similar field for beam indication), that indicates one of a first RS to use for determining the UL spatial domain transmission filter; (10) the latest DL-related DCI with or without DL assignment that includes a TCI state field (or similar field for beam indication), that indicates one of a second RS to use for determining the UL spatial domain transmission filter; (11) a purpose-designed DL channel for beam indication that includes a TCI state field (or similar field for beam indication), that indicates one of a first RS to use for determining the UL spatial domain transmission filter; and/or (12) a purpose-designed DL channel for beam indication that includes a TCI state field (or similar field for beam indication), that indicates one of a second RS to use for determining the UL spatial domain transmission filter.

While the previous steps and FIG. 17 are described for 4-step RACH procedure (i.e., Type 1 random access procedure), it should be apparent that the same principle can be applied to 2-step RACH procedure (i.e., Type 2 random access procedure), wherein a first RACH message from the UE to the gNB (e.g., MsgA) combines the preamble and Msg3. A second RACH message from the gNB to the UE can combine the RAR and Msg4. The second RS (from UE to gNB) is indicated, configured or included in MsgA, the corresponding beam measurement report and/or selected beam indication is included in MsgB. The first RS (from gNB to UE) is indicated, configured or included in MsgB, the corresponding beam measurement report and/or selected beam indication is included in a subsequent UL transmission from the UE to the gNB.

For the determination of the SSB in step 2 of FIG. 17, this can be according to one of more of the following examples.

In one example, the SSB is determined such that the measured SSB L1-RSRP exceeds a threshold provided to the UE in the system information (e.g., remaining minimum system information or SIB1).

In one example, the SSB is determined such that the measured SSB L1-SINR exceeds a threshold provided to the UE in the system information (e.g., remaining minimum system information or SIB1).

In one example, the SSB is determined to be the SSB with the highest L1-RSRP.

In one example, the SSB is determined to be the SSB with the highest L1-SINR.

In one example, the UE determines the pathloss (PL) associated with each SSS(x), such that PL(x)=Reference Power of SSB(x)−RSRP of SSB(x), wherein the RSRP of SSB(x) can be one of: L1-RSRP or higher layer filtered RSRP. The UE determines the PRACH transmit power association with each SSB(x) such that PRACH_Power(x)=PREAMPLE_RECEIVED_TARGET_POWER+PL(x). The UE further determines the maximum transmit power in each beam direction, e.g., associated with SSB(x), PRACH_Power_Max(x), wherein PRACH_Power_Max(x) can take into account any limitations for transmission power in beam direction (spatial domain transmission filter) associated with SSB(x) e.g., due to maximum permissible exposure (MPE).

In such examples: (1) the UE determines an SSB(x) with PRACH_Power(x)<=PRACH_Power_Max(x) (or with PRACH_Power(x)<PRACH_Power_Max(x)); and/or (2) the UE determines an SSB(x) with the smallest PRACH_Power(x).

In one example, the PRACH transmit power is limited to PRACH_Power_Max(x).

The DL RS resource setting can refer to the first RS resource setting included, indicated or configured in the RAR and/or other DL transmissions before the configuration of TCI states.

In one example, the DL RS is NZP-CSI-RS.

In another example, the DL RS is PDSCH DMRS signal for beam management or beam refinement.

In another example, the DL RS is PDCCH DMRS signal for beam management or beam refinement.

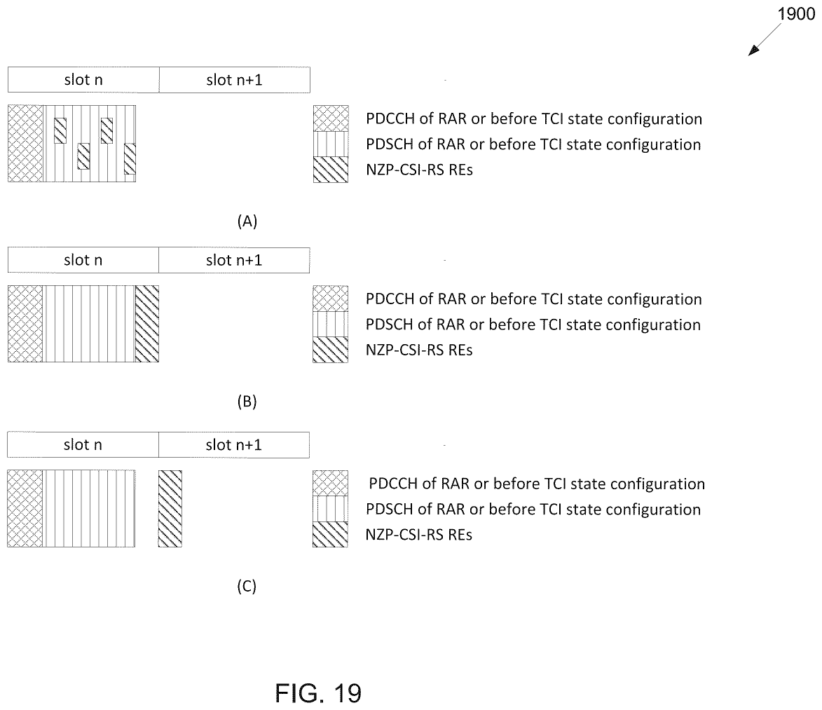

In one example, the DL RS resource setting is included in the RAR or DL PDSCH/PDCCH transmission before TCI states are configured. For example, the DL RS resource setting includes NZP-CSI-RS that is included in the RAR or DL PDSCH/PDCCH transmission before TCI states are configured. The inclusion can be by puncturing or rate matching around some of the RAR PDSCH or RAR PDCCH (or PDSCH or PDCCH before TCI states are configured) resource elements (REs) (e.g., (A) of FIG. 19), or by adding additional symbols in the same slot as the RAR (or PDSCH before TCI states are configured) after or before the RAR PDSCH (or PDSCH before TCI states are configured) for the NZP-CSI-RS (e.g., (B) of FIG. 19) or by adding additional symbols in a different slot for the NZP-CSI-RS (e.g., (C) of FIG. 19).

FIG. 19 illustrates an example of RS setting 1900 according to embodiments of the present disclosure. An embodiment of the RS setting 1900 shown in FIG. 19 is for illustration only.

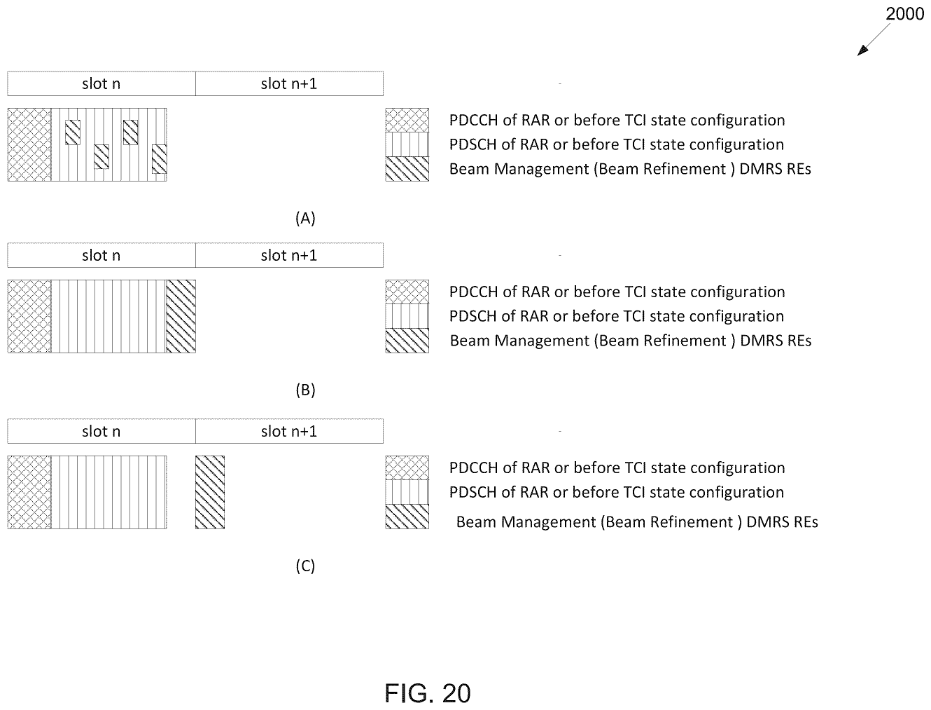

In another example, the DL RS resource setting includes DMRS for beam management (or DMRS for beam refinement) (as described herein) that is included in the RAR or DL PDSCH/PDCCH transmission before TCI states are configured. The inclusion can be by puncturing or rate matching around some of the RAR PDSCH or RAR PDCCH (or PDSCH or PDCCH before TCI states are configured) REs (e.g., (A) of FIG. 20), or by adding additional symbols in the same slot as the RAR (or PDSCH before TCI states are configured) after or before the RAR PDSCH (or PDSCH before TCI states are configured) for the DMRS (e.g., (B) of FIG. 20) or by adding additional symbols in a different slot for the DMRS (e.g., (C) of FIG. 20). In a further example, the PDSCH of the RAR (or PDSCH before TCI states are configured) is configured with N ports, wherein port 0 is for the demodulation of the PDSCH of the RAR (or PDSCH before TCI states are configured), ports 1, . . . N−1 are additional ports for beam management/beam refinement. In one further example, port 0 can be used for both demodulation of the PDSCH as well as well as beam management/refinement. The configuration of the N ports can be by RRC system configuration for example the N can be included in system information (e.g., remaining minimum system information or SIB1).

FIG. 20 illustrates another example of RS setting 2000 according to embodiments of the present disclosure. An embodiment of the RS setting 2000 shown in FIG. 20 is for illustration only.

In one example, the DL RS resource setting (e.g., NZP CSI-RS) is indicated in the RAR or DL PDSCH/PDCCH transmission before TCI states are configured. In this example, configuration for N DL RSs can be provided by higher layer signaling, e.g., in system information (e.g., remaining minimum system information or SIB1). The configuration includes time and frequency resources, scrambling codes, orthogonal cover codes, etc. The time resources can be periodic, in which case the RAR (or PDSCH before TCI states are configured) indicates one or multiple periods after the RAR (or PDSCH before TCI states are configured).

Alternatively, the time resources are relative to the RAR (or PDSCH before TCI states are configured). The frequency resources can be absolute resources within a BWP part or relative to the frequency resources of the RAR (or PDSCH before TCI states are configured). The RAR (or PDSCH before TCI states are configured) can indicate one or more of the N DL RSs provided by higher layers.

In one example, the DL RS resource setting (e.g., NZP CSI-RS) is configured by the RAR (or PDSCH before TCI states are configured). In this example, configuration for N DL RSs can be provided by the RAR (or PDSCH before TCI states are configured)). The configuration includes time and frequency resources, scrambling codes, orthogonal cover codes, etc.

In one example, the DL RS resource setting (e.g., NZP CSI-RS) is configured by a combination of RAR (or PDSCH before TCI states are configured) and higher layer signaling, e.g., in system information (e.g., remaining minimum system information or SIB1), for example some parameters are configure by higher layer signaling and some parameters are configured by the RAR (or PDSCH before TCI states are configured). In a further example, some parameters are configured as a list of values by higher layer signaling and RAR (or PDSCH before TCI states are configured) indicates one value from the list.

In one example, the NZP CSI-RS is configured as a one-shot transmission, across all configured resources or antenna ports.

In another example, the NZP CSI-RS is configured as a M shot transmissions, each shot transmission is across all configured resources or antenna ports. M can be configured by higher layer signaling, e.g., in system information (e.g., remaining minimum system information or SIB1). Alternatively, different ports can be transmitted in different shot transmissions of the M shot transmissions.

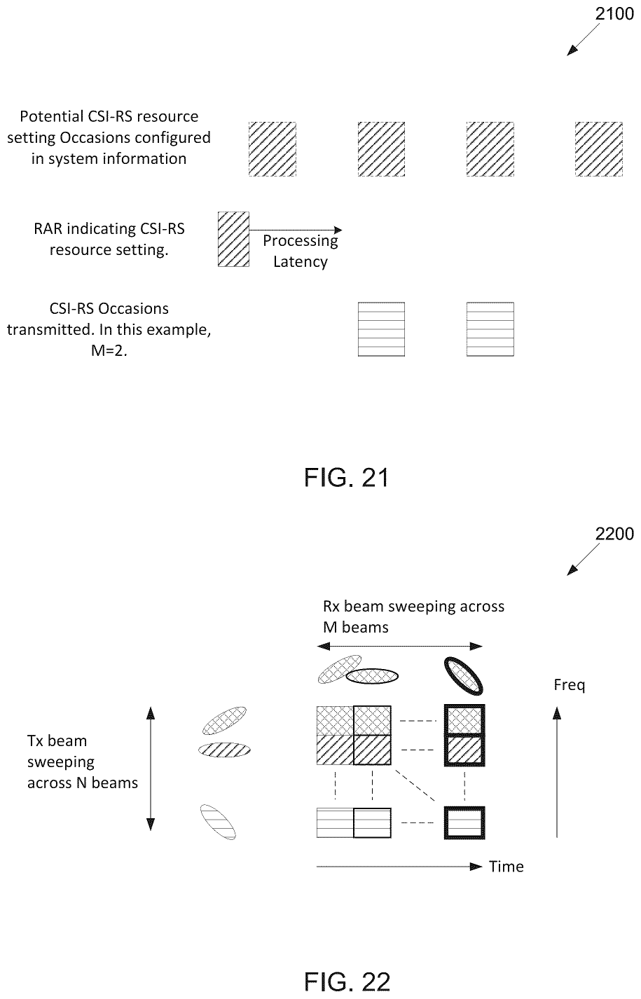

In another example, the NZP CSI-RS is configured as a periodic signal. The UE measures M resources after the transmissions of the RAR (or PDSCH before TCI states are configured) subject to timing restrictions as illustrated in FIG. 21.

FIG. 21 illustrates an example of measuring M transmission resources after the transmission of RAR 2100 according to embodiments of the present disclosure. An embodiment of the measuring M resources after the transmission of RAR 2100 shown in FIG. 21 is for illustration only.

In one example, the first RS resource setting is configured with “repetition off,” wherein the UE may not assume that the first RS resources (e.g., within a resource set) of the first RS resource setting are transmitted with the same DL spatial domain transmission filter (or QCL properties). This allows for transmit beam sweeping at the gNB. The different resources in the same set can be transmitted in different symbols. Alternatively, the different resources in the same set can be transmitted in the same symbol.

In another example, the first RS resource setting is configured with “repetition on,” wherein the UE may assume that the first RS resources (e.g., within a resource set) of the first RS resource setting are transmitted with the same downlink spatial domain transmission filter (or QCL properties). This allows for receive beam sweeping at the UE. The different resources in the same set can be transmitted in different symbols. Alternatively, the different resources in the same set can be transmitted in the same symbol.

In another example, the first RS resource setting is configured with “repetition partially on,” wherein the first RS resource setting is partitioned into N subsets of first RS resources, each subset includes M RS resources, and: (1) the UE may assume that the first RS resources within the same subset are transmitted with the same downlink spatial domain transmission filter (or QCL properties); and (2) the UE may not assume that the first RS resources in different subsets are transmitted with the same downlink spatial domain transmission filter (or QCL properties). In one example, the RX beam sweeping across M beams can be in time and TX beam sweeping across N beams can be in frequency as illustrated in FIG. 22. In another example, the RX beam sweeping across M beams can be in frequency and TX beam sweeping across N beams can be in time.

FIG. 22 illustrates an example of RS resource 2200 setting according to embodiments of the present disclosure. An embodiment of the RS resource 2200 shown in FIG. 22 is for illustration only.

In one example, the selected beam indicator in step 6 of FIG. 17 can be based on the measurements of the first RSs, wherein a UE indicates a preferred first RS ID for subsequent reception and/or transmission from and/or to the gNB.

The UL RS resource setting can refer to the second RS resource setting included, indicated or configured in Msg3 and/or other UL transmissions before the configuration of TCI states.

In one example, the UL RS is SRS.

In another example, the UL RS is PUSCH DMRS signal for beam management or beam refinement.

In another example, the UL RS is PUCCH DMRS signal for beam management or beam refinement.

FIG. 23 illustrates yet another example of RS setting 2300 according to embodiments of the present disclosure. An embodiment of the RS setting 2300 shown in FIG. 23 is for illustration only.

In one example, the UL RS resource setting is included in Msg3 or UL PUSCH transmission before TCI states are configured. For example, the UL RS resource setting includes SRS (as described herein) that is include in Msg3 or UL PUSCH transmission before TCI states are configured. The inclusion can be by puncturing or rate matching around some of the Msg3 PUSCH (or UL PUSCH before TCI states are configured) REs (e.g., (A) of FIG. 23), or by adding additional symbols in the same slot as Msg3 (or UL PUSCH before TCI states are configured) after or before the Msg3 PUSCH (or UL PUSCH before TCI states are configured) for the SRS (e.g., (B) of FIG. 23) or by adding additional symbols in a different slot for the SRS (e.g., (C) of FIG. 23).

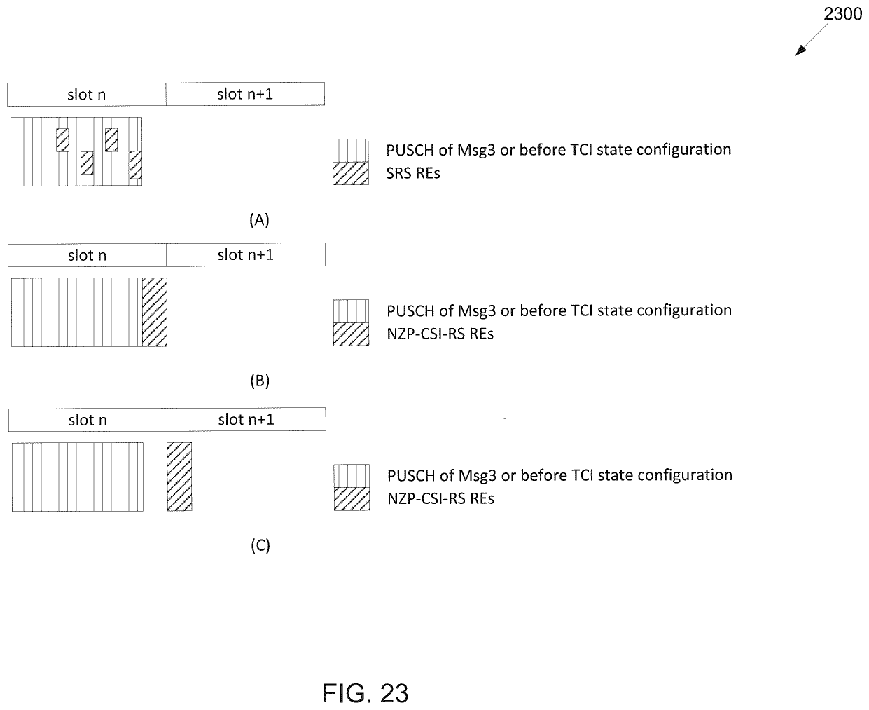

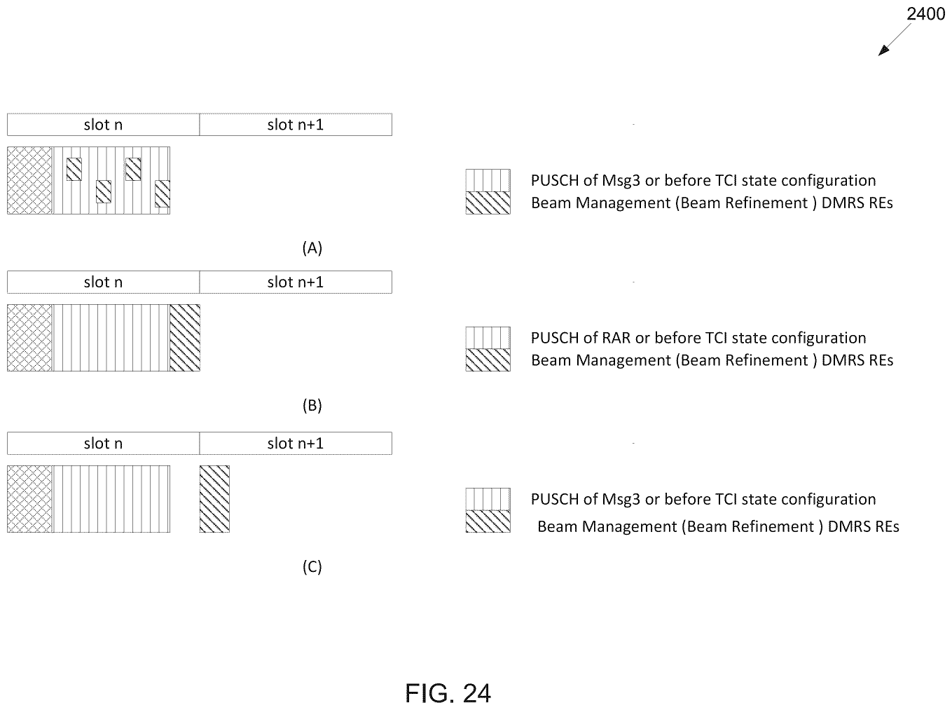

FIG. 24 illustrates yet another example of RS setting 2400 according to embodiments of the present disclosure. An embodiment of the RS setting 2400 shown in FIG. 24 is for illustration only.

In another example, the UL RS resource setting includes DMRS for beam management (or DMRS for beam refinement) (as described herein) that is included in Msg3 or UL PUSCH transmission before TCI state are configured. The inclusion can be by puncturing or rate matching around some of the Msg3 PUSCH (or UL PUSCH before TCI states are configured) REs (e.g., (A) of FIG. 24), or by adding additional symbols in the same slot as Msg3 (or UL PUSCH before TCI states are configured) after or before the Msg3 PUSCH (or UL PUSCH before TCI states are configured) for the DMRS (e.g., (B) of FIG. 24) or by adding additional symbols in a different slot for the DMRS (e.g., (C) of FIG. 24). In a further example, the PUSCH of Msg3 (or UL PUSCH before TCI states are configured) is configured with N ports, wherein port 0 is for the demodulation of the PUSCH of Msg3 (or UL PUSCH before TCI states are configured), ports 1, . . . N−1 are additional ports for beam management/beam refinement. In one further example, port 0 can be used for both demodulation of the PUSCH as well as well as beam management/refinement. The configuration of the N ports can be by RRC system configuration for example the N can be included in system information (e.g., remaining minimum system information or SIB1).

In one example, the UL RS resource setting (e.g., SRS) is indicated in Msg3 PUSCH or RAR (e.g., RAR UL grant) or UL PUSCH transmission before TCI states are configured. In this example, configuration for N UL RSs can be provided by higher layer signaling, e.g., in system information (e.g., remaining minimum system information or SIB1). The configuration includes time and frequency resources, scrambling codes, orthogonal cover codes, etc. The time resources can be periodic, in which case the Msg3 (or UL PUSCH before TCI states are configured) indicates one or multiple periods after Msg3 (or UL PUSCH before TCI states are configured).

Alternatively, the time resources are relative to Msg3 or RAR (or UL PUSCH before TCI states are configured). The frequency resources can be absolute resources within a BWP part or relative to the frequency resources of Msg3 or RAR (or UL PUSCH before TCI states are configured). Msg3 or RAR (e.g., RAR UL grant) (or UL PUSCH before TCI states are configured) can indicate one or more of the N UL RSs provided by higher layers.

In one example, the UL RS resource setting (e.g., SRS) is configured by the Msg3 or RAR (or UL PUSCH before TCI states are configured). In this example, configuration for N UL RSs can be provided by Msg3 or RAR (or UL PUSCH before TCI states are configured)). The configuration includes time and frequency resources, scrambling codes, orthogonal cover codes, etc.

In one example, the UL reference resource setting (e.g., SRS) is configured by a combination of Msg3 or RAR (or UL PUSCH before TCI states are configured) and higher layer signaling, e.g., in system information (e.g., remaining minimum system information or SIB1), for example some parameters are configure by higher layer signaling and some parameters are configured by Msg3 or RAR (or UL PUSCH before TCI states are configured). In a further example, some parameters are configured as a list of values by higher layer signaling and Msg3 or RAR (or UL PUSCH before TCI states are configured) indicates one value from the list.

In one example, the SRS is configured as a one-shot transmission, across all configured resources or antenna ports.

In another example, the SRS is configured as a M shot transmissions, each shot transmission is across all configured resources or antenna ports. M can be configured by higher layer signaling, e.g., in system information (e.g., remaining minimum system information or SIB1). Alternatively, different ports can be transmitted in different shot transmissions of the M shot transmissions.

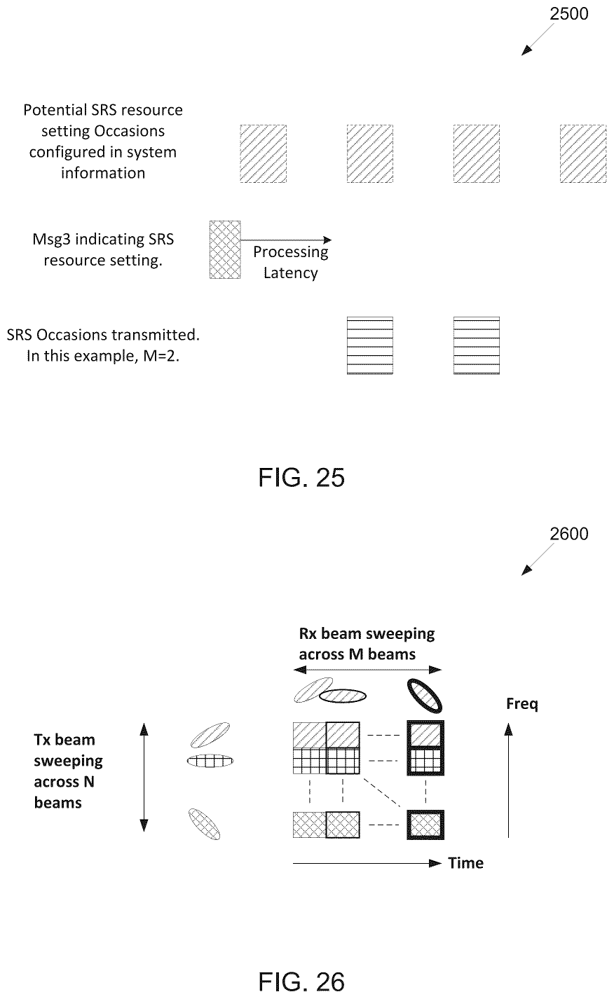

FIG. 25 illustrates another example of measuring M transmission resources after the transmission of Msg3 2500 according to embodiments of the present disclosure. An embodiment of the measuring M resources after the transmission of Msg3 2500 shown in FIG. 25 is for illustration only.

In another example, the SRS is configured as a periodic signal. The gNB measures M resources after the transmissions of the Msg3 (or UL PUSCH before TCI states are configured) subject to timing restrictions as illustrated in FIG. 25.

In one example, the second RS resource setting is configured with “repetition off,” wherein the gNB may not assume that the second RS resources (e.g., within a resource set) of the second RS resource setting are transmitted with the same UL spatial domain transmission filter (i.e., the UE can use a different spatial domain transmission filter for each second RS resource). This allows for transmit beam sweeping at the UE. The different resources in the same set can be transmitted in different symbols. Alternatively, the different resources in the same set can be transmitted in the same symbol.

In another example, the second RS resource setting is configured with “repetition on,” wherein the gNB may assume that the second RS resources (e.g., within a resource set) of the second RS resource setting are transmitted with the same UL spatial domain transmission filter (i.e., the UE uses the same spatial domain transmission filter for each second RS resource). This allows for receive beam sweeping at the gNB. The different resources in the same set can be transmitted in different symbols. Alternatively, the different resources in the same set can be transmitted in the same symbol.

In another example, the second RS resource setting is configured with ‘repetition partially on’, wherein the second RS resource setting is partitioned into N subsets of second RS resources, each subset includes M RS resources, and: (1) the gNB may assume that the second RS resources within the same subset are transmitted with the same UL spatial domain transmission filter (i.e., the UE uses the same spatial domain transmission filter for each second RS resource in the same subset); and/or (2) the gNB may not assume that the second RS resources in different subsets are transmitted with the same UL spatial domain transmission filter (i.e., the UE can use a different spatial domain transmission filter for second RS resources in different subsets). In one example, the RX beam sweeping across M beams can be in time and TX beam sweeping across N beams can be in frequency as illustrated in FIG. 26. In another example, the RX beam sweeping across M beams can be in frequency and TX beam sweeping across N beams can be in time.

FIG. 26 illustrates another example of RS resource setting 2600 according to embodiments of the present disclosure. An embodiment of the RS resource setting 2600 shown in FIG. 26 is for illustration only.

In one example, the selected beam indicator in step 11 can be based on the measurements of the second RSs, wherein a gNB signals a second RS ID for subsequent reception and/or transmission from and/or to the UE.

Step A1: A UE is provided information about SSBs and association between: (1) SSBs and RACH Occasions (ROs), and/or (2) SSBs and preambles.

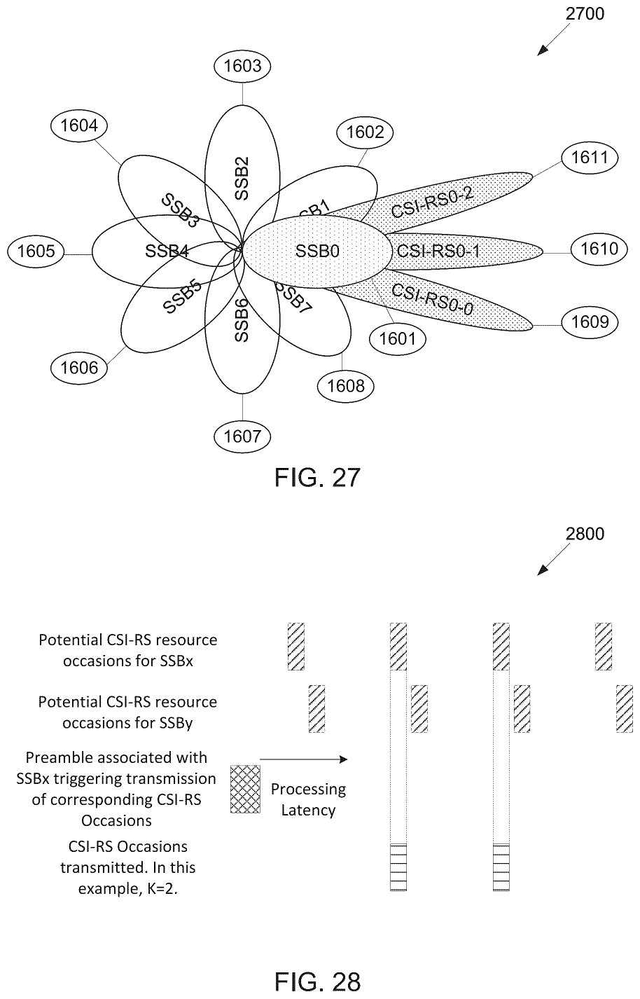

FIG. 27 illustrates an example of SSB association 2700 according to embodiments of the present disclosure. An embodiment of the SSB association 2700 shown in FIG. 27 is for illustration only.

The UE is further provided a configuration of DL reference signal resources (e.g., CSI-RS resource setting) and an association between SSBs and the CSI-RS resources (e.g., in the system information (e.g., remaining minimum system information or SIB1) or in the MIB). An illustration of this association is shown in FIG. 27. In the example of FIG. 27, SSB0 is associated with CSI-RS0-0, CSI-RS0-1 and CSI-RS0-2. In general, any SSB, e.g., SSBn is associated with CSI-RSn-m, wherein m=0, 1, . . . , M−1. M can be configured by RRC signaling (e.g., in the system information (e.g., remaining minimum system information or SIB1) or in the MIB).

In a further example, the value of M can depend on n, e.g., SSBn is associated with CSI-RSn-m, wherein m=0, 1, . . . , M(n)−1. M(n) can be configured by RRC signaling (e.g., in the system information (e.g., remaining minimum system information or SIB1) or in the MIB). N can be the number of SSBs, N can be configured by RRC signaling (e.g., in the system information (e.g., remaining minimum system information or SIB1) or in the MIB). N and/or M can be specified in the system specification. For example, N can equal 8 in FR1, and N can equal 64 in FR2.

Step A2: The UE determines an SSB, the determination of the SSB can be as described earlier in this disclosure and selects an RO and a preamble within that RO associated with the SSB. UE transmits PRACH on selected RO and preamble. In case of beam correspondence at the UE without beam sweeping, the UE can determine the spatial domain transmission filter for the PRACH transmission based on the spatial domain receive filter of the corresponding SSB. In case of no beam correspondence at the UE, the UE tries different hypothesis of the spatial domain transmission filter for the preamble until the UE gets a RAR response from the gNB.

FIG. 28 illustrates an example of CSI-RS transmission 2800 according to embodiments of the present disclosure. An embodiment of the CSI-RS transmission 2800 shown in FIG. 28 is for illustration only.

Step A3: A gNB detects preamble and triggers the transmission of the CSI-RS resources associated with the SSB corresponding to the detected preamble, the association is as described in step A1. The transmission of the CSI-RS in response to the detection of the preamble, subject to processing and/or measurement latency restrictions (e.g., a time delay after the preamble), can be as shown in FIG. 28. The gNB can transmit K CSI-RS occasions in response to a detected preamble. K can be configured by RRC signaling (e.g., in the system information (e.g., remaining minimum system information or SIB1) or in the MIB) or can be specified in the system specifications. The processing (e.g., measurement) latency can be configured by RRC signaling (e.g., in the System Information (e.g., Remaining Minimum System Information or SIB1) or in the MIB) or can be specified in the system specifications. In a further example, the processing latency can depend on a UE capability. In each CSI-RS occasions where CSI-RS is transmitted, all the CSI-RS resources associated with the SSB (e.g., M CSI-RS resources associated with SSBx) are transmitted. Alternatively, a subset of these resources is transmitted in each CSI-RS occasion, different subsets can be transmitted in different occasions.

In one example, the CSI-RS resource associated with the SSBs for beam refinement are always transmitted by the gNB, with a configuration provided by RRC signaling (e.g., in the system information (e.g., remaining minimum system information or SIB1) or in the MIB).

Step A4: In addition to step 3 of FIG. 17, in response to the detected preamble, the gNB transmits an RAR. The RAR includes an UL grant that schedules a Msg3 transmission from the UE.

Step A5: The UE after transmitting the preamble and subject to timing restrictions measures the CSI-RS resources associated with the SSB associated with the preamble the UE transmitted. In one example, the timing of the measurement of the CSI-RS resources can be after the transmission of the RAR. In a second example, the timing of the measurement of the CSI-RS resources can be before the transmission of the RAR.

Step 6A: The UE receives the RAR.

Step A7: The UE transmits Msg3 in response to the RAR: (1) Msg3 can be transmitted on a UE-selected beam with a spatial domain transmission filter determined based on the measurement of the CSI-RS resources associated with the SSB associated with the preamble; (2) Msg3 can be transmitted on a UE-selected beam with a spatial transmission filter determined based on the measurement of the CSI-RS resources associated with the SSB associated with the preamble. Msg3 further includes a selected beam indicator, or a measurement report based on the measurement of the CSI-RS resources associated with the SSB associated with the preamble; and/or (3) Msg3 can be transmitted on the same beam (i.e., same spatial domain transmission filter) as used for the corresponding preamble transmission. Msg3 further includes a selected beam indicator, or a measurement report based on the measurement of the CSI-RS resources associated with the SSB associated with the preamble.

Step A8: The gNB receives Msg3 based on the UL grant of the RAR: (1) the gNB can use the same spatial domain reception filter as that used for the preamble in step 3 of FIG. 17; and/or (2) the gNB can use a spatial domain reception filter corresponding to the one of the spatial domain transmission filters of the CSI-RS resources associated with the SSB associated with the preamble. Multiple receive hypothesis may be needed to successfully receive Msg3.

Step A9: The gNB transmits Msg4 in response to Msg3 using a spatial domain transmission filter based on the selected beam indicator or a measurement report in Msg3.

Step A10: The UE receives Msg4 using a spatial domain reception filter based on the selected beam indicator or a measurement report in Msg3.

Step A11: The UE transmits PUCCH in response to Msg4 using a spatial domain transmission filter based on the selected beam indicator or a measurement report in Msg3.

While the previous steps A1 to A11 are described for 4-step RACH procedure (i.e., Type 1 random access procedure), it should be apparent that the same principle can be applied to 2-step RACH procedure (i.e., Type 2 random access procedure), wherein a first RACH message from the UE to the gNB (e.g., MsgA) combines the preamble and Msg3. A second RACH message from the gNB to the UE can combine the RAR and Msg4. After the UE transmits MsgA and the gNB detects the preamble, the UE can measure CSI-RS resources associated with the preamble subject to timing restrictions (e.g., based on the preamble or based on MsgB). In one example, the measured CSI-RS resources can be before MsgB. In a second example, the measured CSI-RS resource can be after MsgB (e.g., subject to a timing restriction).

In the present disclosure, the beam measurement report including the MPE effect has the measurement RS or UL/Joint TCI State arranged in order of preference for the UE. From the beam measurement report, the gNB can select the most preferred beam that meets the power of an UL transmission from the UE.

A beam-based operation is essential for the commercialization of FR2 (i.e., mmWaves), support of beam management in release 15 and release 16 incurs overhead and latency impacting the robustness of beam management. One of the components of the present disclosure is to enhance beam management operation by making beam management more efficient (i.e., less overhead and less latency), e.g., during initial access.

The above flow charts and diagrams illustrate example methods that can be implemented in accordance with the principles of the present disclosure and various changes could be made to the methods illustrated in the flow charts and diagrams herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential clement that must be included in the claims scope. The scope of patented subject matter is defined by the claims.

What is claimed is:

1. A user equipment (UE) in a wireless communication system, the UE comprising:
a processor; and
a transceiver operably coupled with the processor, the transceiver configured to:
receive, from a base station, information configuring a maximum permissible exposure (MPE) resource, and
transmit, to the base station, a medium access control (MAC) control element (CE) including first information associated with a power management maximum power reduction (P-MPR) value and second information associated with the MPE resource,
wherein the P-MPR value corresponds to a power backoff to meet MPE requirements.

2. The UE of claim 1, wherein the MPE resource includes a synchronization signal and physical broadcast channel block (SSB) or a channel state information-reference signal (CSI-RS).

3. The UE of claim 1, wherein the MAC CE further includes third information indicating a maximum UE transmit power.

4. The UE of claim 1, wherein the information configuring the MPE resource is received via a radio resource control (RRC) signaling.

5. A base station in a wireless communication system, the base station comprising:
a processor; and
a transceiver operably coupled with the processor, the transceiver configured to:
transmit, to a user equipment (UE), information configuring a maximum permissible exposure (MPE) resource, and
receive, from the UE, a medium access control (MAC) control element (CE) including first information associated with a power management maximum power reduction (P-MPR) value and second information associated with the MPE resource,
wherein the P-MPR value corresponds to a power backoff to meet MPE requirements.

6. The base station of claim 5, wherein the MPE resource includes a synchronization signal and physical broadcast channel block (SSB) or a channel state information-reference signal (CSI-RS).

7. The base station of claim 5, wherein the MAC CE further includes third information indicating a maximum UE transmit power.

8. The base station of claim 5, wherein the information configuring the MPE resource is transmitted via a radio resource control (RRC) signaling.

9. A method performed by a user equipment (UE) in a wireless communication system, the method comprising:
receiving, from a base station, information configuring a maximum permissible exposure (MPE) resource; and
transmitting, to the base station, a medium access control (MAC) control element (CE) including first information associated with a power management maximum power reduction (P-MPR) value and second information associated with the MPE resource,
wherein the P-MPR value corresponds to a power backoff to meet MPE requirements.

10. The method of claim 9, wherein the MPE resource includes a synchronization signal and physical broadcast channel block (SSB) or a channel state information-reference signal (CSI-RS).

11. The method of claim 9, wherein the MAC CE further includes third information indicating a maximum UE transmit power.

12. The method of claim 9, wherein the information is configuring the MPE resource received via a radio resource control (RRC) signaling.
